(19) United States
(12) Patent Application Publication
(10) Pub. No.: US 2014/0316813 A1
(43) Pub. Date: Oct. 23, 2014

(54) Healthcare Toolkit

(71) Applicant: James D. Bauer, Lebanon, OR (US)

(72) Inventor: James D. Bauer, Lebanon, OR (US)

(21) Appl. No.: 14/259,153

(22) Filed: Apr. 23, 2014

Related U.S. Application Data
(60) Provisional application No. 61/814,928, filed on Apr. 23, 2013.

(51) Int. Cl. G06F 19/00

(52) U.S. Cl. CPC G06F 19/36; G06F 19/3487
USPC 705/3

(57) ABSTRACT

A patient-centered Healthcare Toolkit includes a set of identification (ID) devices to uniquely identify each of a set of patients, a set of electronic tablets having wireless connectivity configured to read the set of ID devices, at least one of the set of electronic tablets being a patient intake tablet to collect patient self-knowledge of their problems. A set of medical measurement devices with wireless connectivity operate with one of the set of electronic tablets to gather at least one of physiologic, radiographic and bio-chemical data, and a local manager station to wirelessly connect with the set of electronic tablets and including an enterprise management system that uses a physician “mental model” of exam flow to create an patient-centered encounter form and any test requisitions for each of the medical measurement devices, and provides correct and consistent guidelines to operators of each of the set of electronic tablets.

### CROSS REFERENCE TO RELATED APPLICATION

This application claims the benefit of pending U.S. Provisional Application 61/814,928 filed Apr. 23, 2013, titled “Bauer Labs Healthcare Toolkit”, which is hereby incorporated by reference.

### FIELD OF THE INVENTION

The present invention relates generally to method and apparatus for a Healthcare Toolkit. More specifically, the present invention is a method and apparatus for a Healthcare Toolkit that reduces healthcare inefficiencies by providing an inventive, integrative, and well-engineered process management system to all levels of healthcare providers and management.

### BACKGROUND

Currently, there are a multitude of barriers that inhibit communication and limit a patient's access to quality care. The public health and the medical literature document these societal problems as well as the maladaptive characteristics of existing healthcare system.

### BRIEF DESCRIPTION OF THE DRAWINGS

The present invention is better understood with reference to the following drawings. The elements of the drawings are not necessarily to scale relative to each other. Rather, emphasis has instead been placed upon clearly illustrating the present invention. Furthermore, like reference numerals designate corresponding similar parts through the several views.

FIG. 1A is a drawing of an example of a Healthcare Toolkit;

FIG. 1B is an example schematic of a Healthcare Toolkit;

FIG. 2 is a flowchart of the barriers creating disparity in healthcare;

FIG. 3 is a flowchart of the adapted Wickens model of human information processing;

FIG. 4A is an example IDEF0 A-0 drawing used in creating the Healthcare Toolkit;

FIG. 4B is an example schematic of a physician's “mental model” of a patient medical encounter;

FIG. 5 is a flow chart of an example Healthcare Toolkit in a clinical environment;

FIG. 6 is a left-side perspective CAD drawing of the Human-Machine Systems (HMS) driven design of an example Healthcare Toolkit;

FIGS. 7A-7L are example CAD drawings of various components of an example Healthcare Toolkit illustrating further the HMS driven design;

FIGS. 8A and 8B are example encounter forms illustrating the HMS driven design;

FIG. 9 is a flow chart of an example Healthcare Toolkit in an emergency response environment;

FIG. 10 is a flow chart of an example controlling algorithm for the enterprise management system (EMS) used with example Healthcare Toolkits;

FIG. 11 is an example of an agent-base implementation of an example controlling algorithm for the EMS in an example Healthcare Toolkit;

FIG. 12 is an example encounter screen with a checklist used in an example Healthcare Toolkit;

FIG. 13 is a diagnostic flow chart implementing an example debiasing algorithm in the present invention;

FIGS. 14-18 are example CAD screen shots of a treatment work table's encounter forms and user interface in accordance with aspects of the present invention;

FIGS. 19A and 19B illustrate an example ID device using RFID which may be used in some examples of the present invention; and

FIG. 20 is an example ID device using text and barcode which may be used in some examples of the present invention.

### DETAILED DESCRIPTION

It is an object of the present invention to introduce a new method and apparatus for a Healthcare Toolkit that reduces healthcare inefficiencies by providing an inventive, integrative, and well-engineered process management system to all levels of healthcare providers and management. All illustrations of the drawings are for the purpose of describing selected example versions of the present invention and are not intended to limit the scope of the present invention. The present invention may be referred to hereinafter as the “Healthcare Toolkit” or simply “HCT”. The HCT allows for pop-up clinics and general health screenings. The HCT integrates well with various patient centered medical homes such as clinics, hospitals, medical practices, nursing homes, convalescent homes, hospice care, and the like by providing for secure data transfer to and from the medical homes own databases. The central concept of many of the features of the HCT is patient centered with support features to enable the physician/provider to more accurately, reliably, an efficiently deliver patient care, education, consoling/therapy, and education/habit change. Further, the HCT system provide a necessary ready portal for tele-medicine.

It should be noted that the drawings are not true to scale. Further, various parts of the elements have not been drawn to scale. Certain dimensions have been exaggerated in relation to other dimensions in order to provide a clearer illustration and understanding of the present invention.

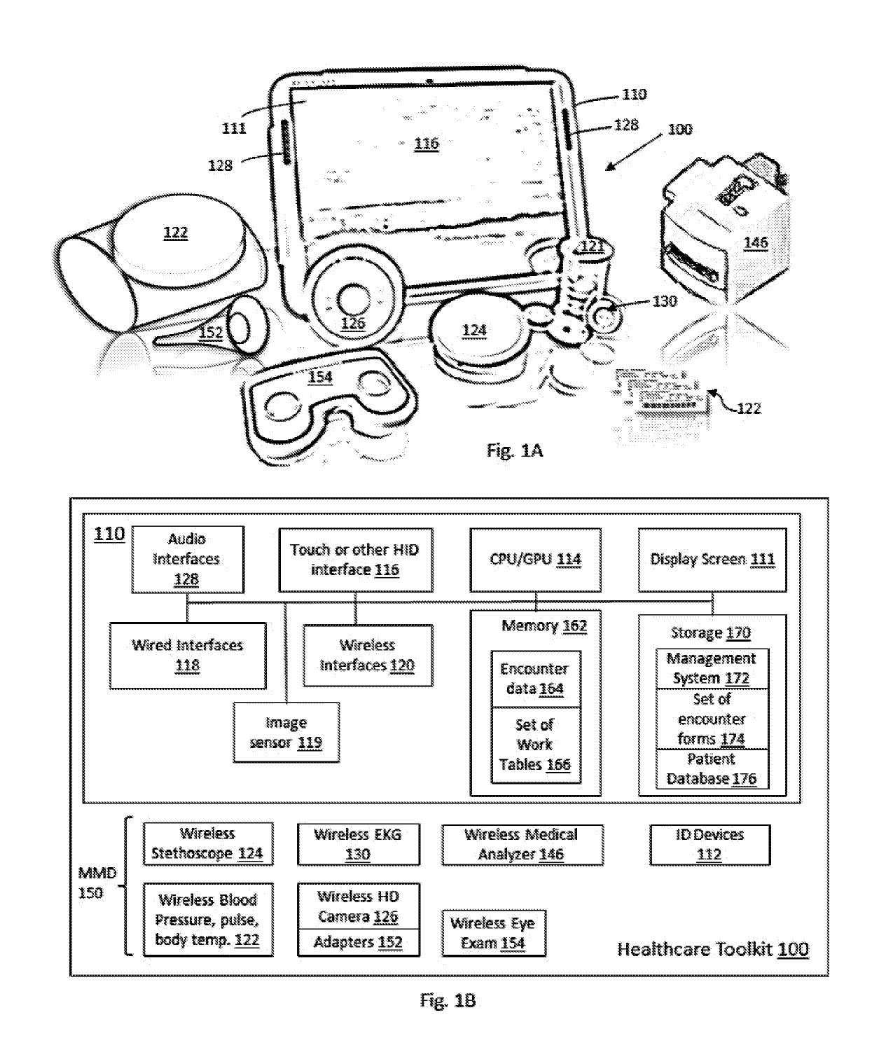

Examples in accordance with the present invention relate to methods and apparatus for an intelligent human-machine interface to control the Healthcare Toolkit 100 (see FIG. 1A). By way of example, but not limited thereto, examples of methods and apparatus are presented of an intelligent human-machine interface for the Healthcare Toolkit (HCT) 100 and more particularly, to systems and processes for real-time management and feedback of process control, situational awareness, logistics, communication, and documentation, herein referred to as a smart system enterprise management system (EMS) 172 (see FIG. 1B). One element of the EMS 172, among others, provides a knowledge base that organizes information and rules that enables an accurate, relevant, and timely healthcare encounter support system. The knowledge base is represented in a hierarchical structure of functions and systems. The smart system EMS 172 serves as platform for the avoidance, detection, and timely correction of errors; and as such, acts as a countermeasure to error while being patient-centered and improves efficiency of healthcare professionals and patient satisfaction.

### Description of Healthcare Toolkit:

FIG. 1A is a CAD drawing illustrating an example of a Healthcare Toolkit 100 described within this specification. FIG. 1B is an example schematic diagram of the HCT 100. A HCT 100 includes one or more electronic tablets 110 or other portable electronic devices such as an iPad, Android, Windows RT, Windows, iOS tablets, cellphones, satellite phones, PDAs, notebook computers, phablets, or like-type devices and operating systems all herein referred to as an “electronic tablet(s)” for ease of understanding.

The electronic tablet 110 has a display screen 111, one or more wireless interfaces 120, possibly one or more wired interfaces 118, a central processing unit (CPU) with an integrated or discrete graphics processing unit (GPU) 114 for controlling the display screen 111, tangible and non-transitory computer readable memory 162, tangible and non-transitory computer readable storage 170, a touch interface 116 such as a touch screen, a track pad, trackball, or mouse or HID interface (in some examples a keyboard), an image sensor 119, and an audio interface 128 with speakers, microphone, and headphone jack. Data or programs may be transferred between memory 162 and storage 170 as needed by the CPU/GPU 114. The HCT 100 also includes a set of medical measurement devices (MMD) 150 such as a wireless Hi-Definition camera 126 (with possibly various adapters 152 for eye, ear, nose, throat, microscope, or epidermal viewing), a wireless electronic stethoscope 124, and a wireless set of EKG probes 130 and a container 121 to hold the EKG probes 130. Other wireless MMDs 150 may be a biometric or other identification device such as a fingerprint reader, iris scanner and mapper, camera for photograph of patient and facial recognition. Further biometric MMDs 150 include a wireless blood pressure cuff 122, which may include a pulse sensor and body temperature sensor(s), a wireless eye exam device 154, pulmonary sensors, and wireless medical analyzers 146 such as blood chemistry, urine analysis, blood glucose and cholesterol readers as a few examples.

Wireless connectivity to the electronic tablet can be done using wireless networking such as IEEE 802.11 a/b/g/ac or wireless Bluetooth protocols, RFID protocols, or equivalent. In some examples there may be a provision for wired interfaces 118 when wireless operability is not possible or desired. Such wired interfaces can include USB ver. 2.0, USB ver. 3.0, various forms of Ethernet, Lightning Bolt, Fire-wire, or Display Port and equivalents. The CPU/GPU 114 may be an x86-based 32 bit or 64 bit single or multicore processor from Intel or AMD, or it may be 32 bit or 64 bit single or multicore ARM based processor or equivalents available from many sources such as Qualcomm, Samsung, or NVidia or other semiconductor supplier.

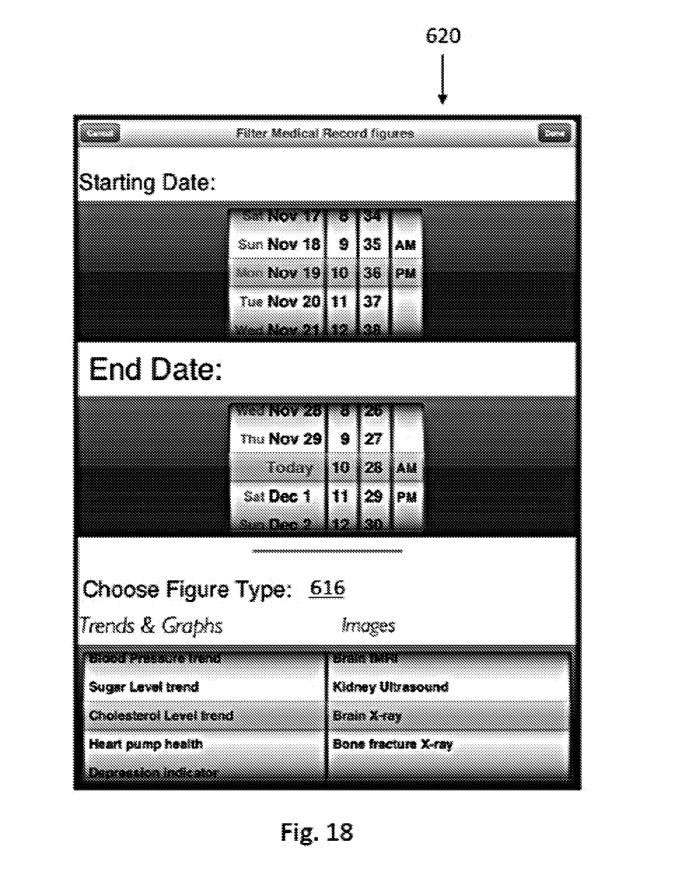

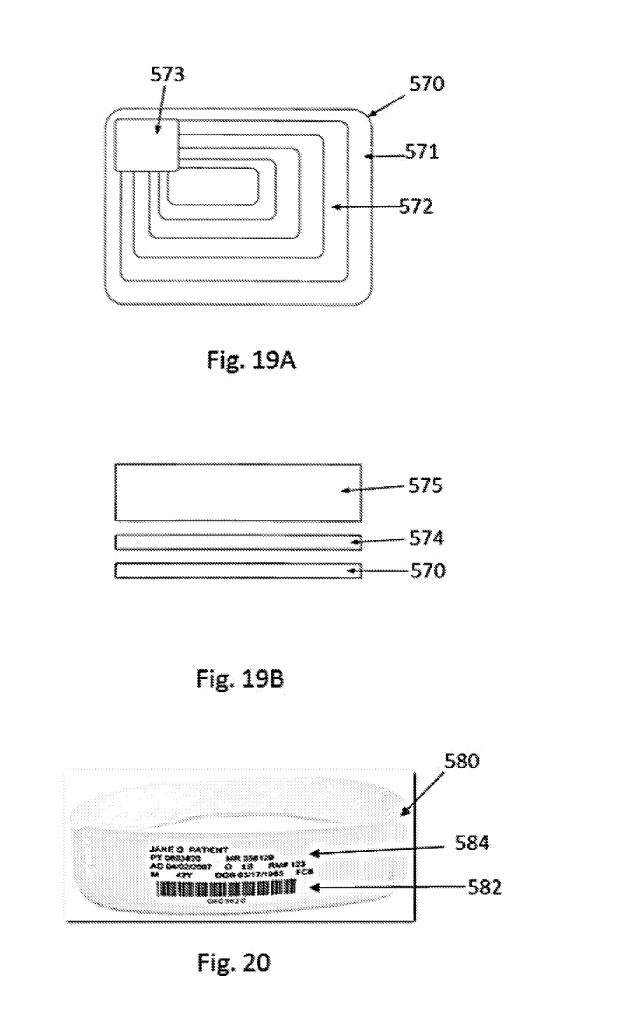

The HCT 100 may also include a set of identification (ID) devices 112 to uniquely identify each of a set of patients. These ID devices 112 (see FIGS. 19A-19B and 20 for some examples) may include 1D, 2D, 3D, or holographic barcodes, RFID tags, NFC devices, magnetic strips, or other electromagnetically read devices to ensure that the patient is always uniquely identified during all stages of the encounter process. The HCT 100 may also identify the patient with biometrics such as with a fingerprint scanner, iris scanner and mapper, and photograph and facial recognition. Such biometric identification in electronic form is also an ID device 112. In some situations such as health fairs for homeless, the specific individual identity may wish to be concealed. However, the health care history and screening data belongs to a specific individual regardless of alias. The HCT 100 can still track an individual with aliases or minimal demographics by using the ID devices 112.

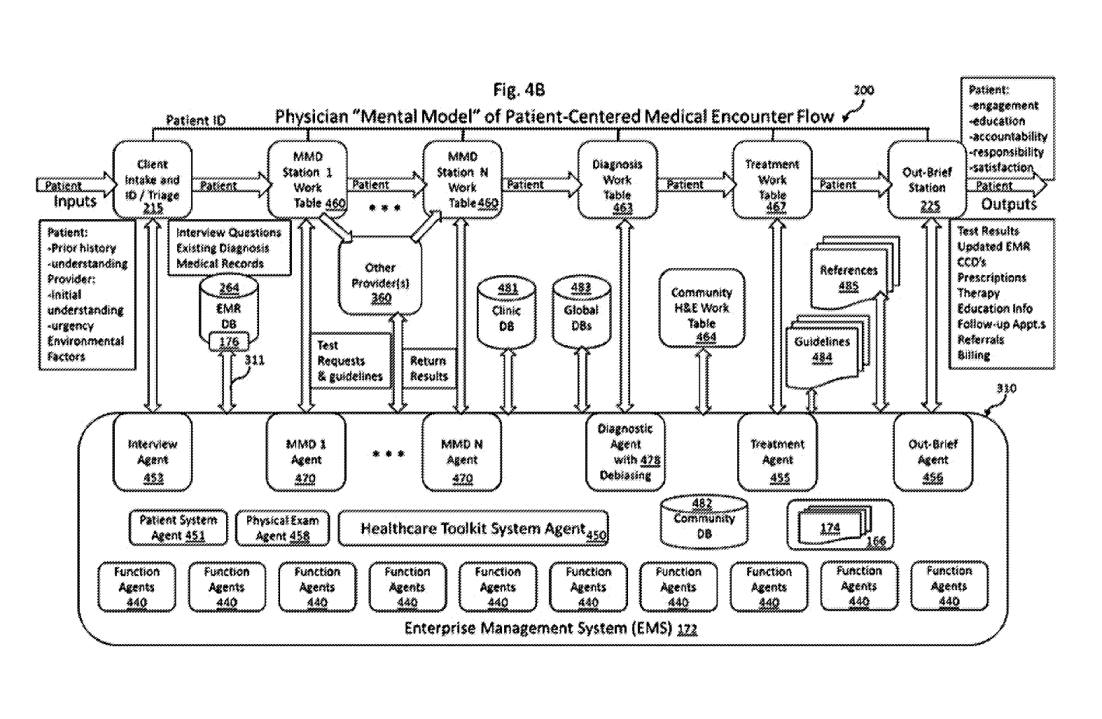

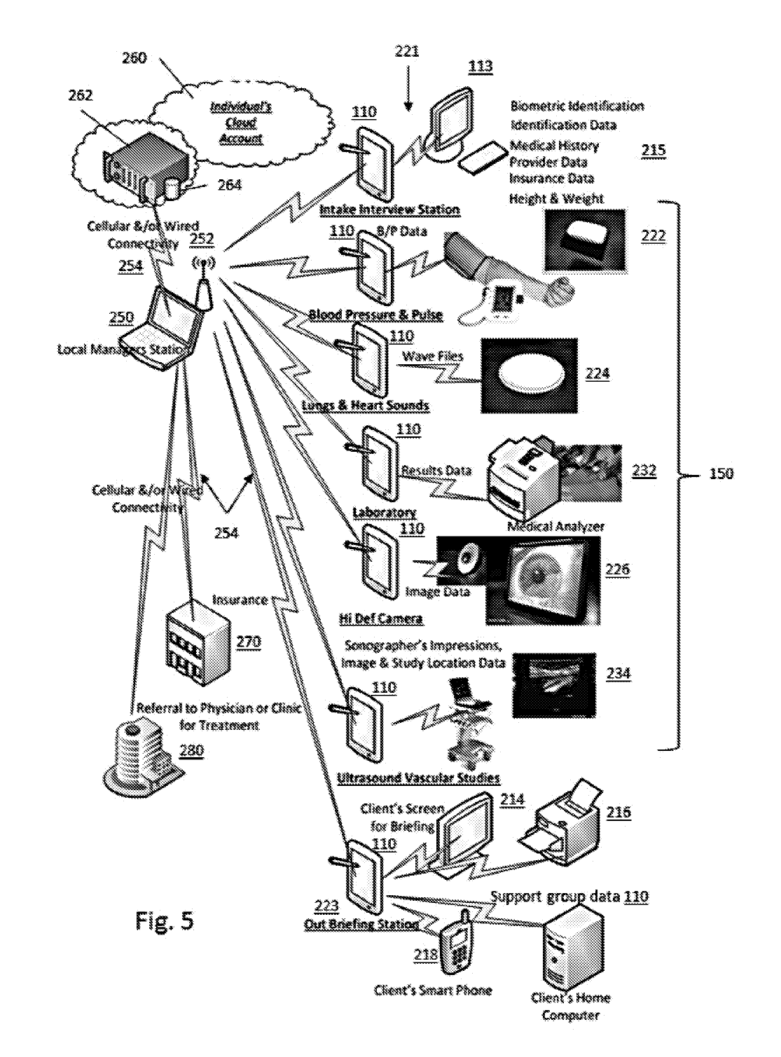

The electronic tablet 110 is accordingly configured to read the set of ID devices 112 or coupled to an adapter to do so. The electronic tablet 110 also includes work tables 166 controlling a set of patient-centered encounter forms 174 along with encounter data 164 that includes a patient intake encounter form to collect patient self-knowledge of their problems. The set of MMDs 150 may be configured with wireless connectivity to operate with the electronic tablet 110 via respective patient-centered encounter forms 174 organized by different functional work tables 166 created from an enterprise management system (EMS) 172 using a physician “mental model” of exam flow (see FIG. 4B) and connected to a patient database 176. The “mental model” was derived from study of provider mental and physical activities then mapping the process into an IDEF 0 model. Just like real life IDEF does not rigidly dictate sequence of activity and activities may occur simultaneously in a complimentary fashion. The EMS 172 may be either locally implemented on the electronic tablet 110 or control the work table 166 and encounter forms 174 from a remote computer system such as a local manager station 250 (see FIG. 5). “Local manager station is used to describe that typically but not necessarily there would be a local manager coordinating a healthcare clinic. The local manager station may be local to the health care clinic or event or may be remotely located. The MMDs 150 in conjunction with the electronic tablet 110 gather at least one of physiologic, physical exam findings, radiographic, and bio-chemical data. The EMS 172 can request any test requisitions for each of the medical measurement devices during the encounter, and provide correct and consistent guidelines to an operator of the electronic tablet 110, such as a physician, clinician, healthcare provider, and patient. More specific detail about the design philosophy and operation of the HCT 100 follows below.

### Healthcare Toolkit Design Philosophy:

### Purpose

The Healthcare Toolkit 100 is an instrument to reduce healthcare inefficiencies by providing an inventive, integrative, and well-engineered process management system to all levels of healthcare providers and management. In some examples, the Health Care Toolkit 100 is a mobile platform that easily coalesces into clinical enterprise systems that enable new models of healthcare delivery integrating every healthcare team member efforts onto a properly aligned plan aimed at patient engagement and behavioral change.

### Understanding the Problem of Disparity in the United States

Disparity has two basic themes: access and communication. There are a multitude of barriers that inhibit communication and limit patents' access to quality care. The public health and the medical literature document these societal problems as well as the maladaptive characteristics of existing healthcare system.

### Barriers Creating Disparity

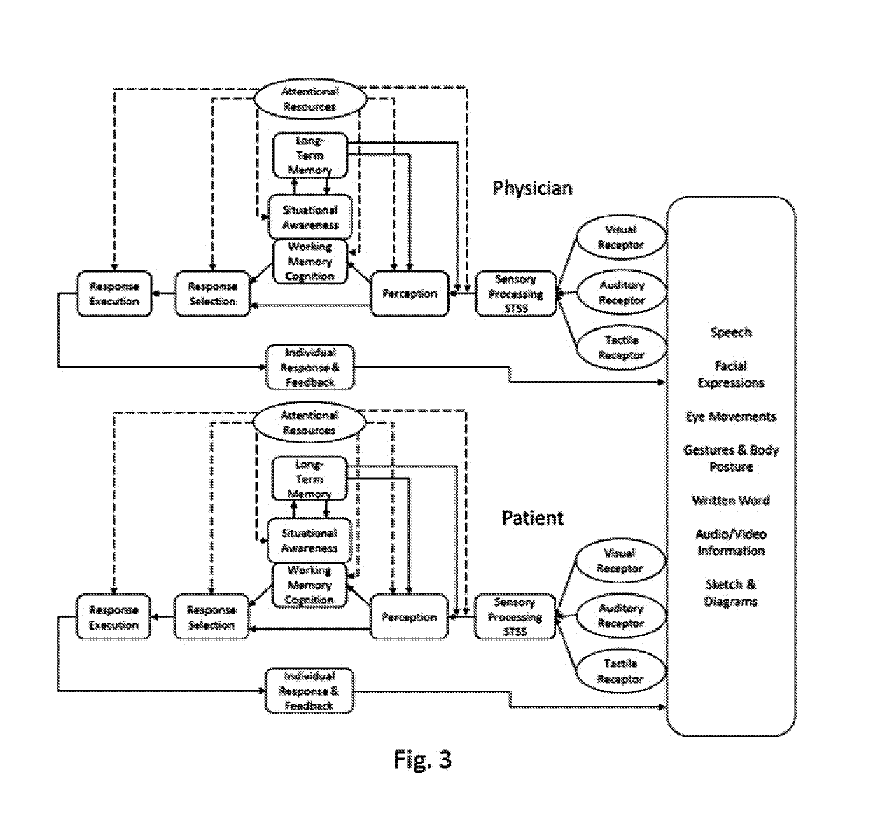

To design a solution, the inventor first cataloged the component problems creating the healthcare disparity. The solution of the HCT 100 organizes the information flow and activities of every encounter with the patient keeping patient betterment as the primary goal. Such solution breaks the barriers of access and communication shown in FIG. 2, which plague the current system. Access, communication, cultural divergence, poorly implemented technology, economic barriers, and patient poverty do not act in isolation. These factors are additive and possibly multiplicative. A scattered set of technological or policy driven solutions just further compound the problem. The Healthcare Toolkit 100 disclosed herein intends to bridge these barriers by providing all healthcare team members an integrative platform from which they can efficiently manage their activities to accomplish the most good possible for the patient. In short, the Healthcare Toolkit 100 is an inventive, well-engineered and complete solution available to both patients and providers at all levels of healthcare providers and process.

### Communication and Engagement

Traditional medicine has a poor legacy of inadequate communication and poor patient engagement. The demographics of the United States shift is creating tectonic forces that are fracturing the traditional physician/patient relationship. Accordingly, the physician/patient relationship and model/protocol for interaction will have to evolve to maintain relevance in our changing multicultural society. Disparity has two major themes: access and communication. As America moves to a more culturally diverse and aging population, the problems of access and communication will become even more acute. Overcoming those barriers that block access and communication is central to creating a healthy patient/physician interaction.

The fundamental disparity within healthcare is the mismatch of medical science expertise between the physician and the patient. This mismatch in turn, creates an interaction that often suppresses questions and deprives the patient the education necessary to understand their situation and options. In many instances the patient simply trusts the physician. However, simple trust may not be enough to fully engage the patient in participating as a principal partner in their personal healthcare. Inadequate educational services and brief office visits are not enough to coach the patient with the new habits required to prevent chronic disease entities that are common for this population. The national conversation is currently focused on the finance of healthcare and ignores the fundamental need for renovation of the basic activity inherent to all healthcare—the physician/patient (or team member/patient) encounter.

### Healthcare is an Encounter and Conversation

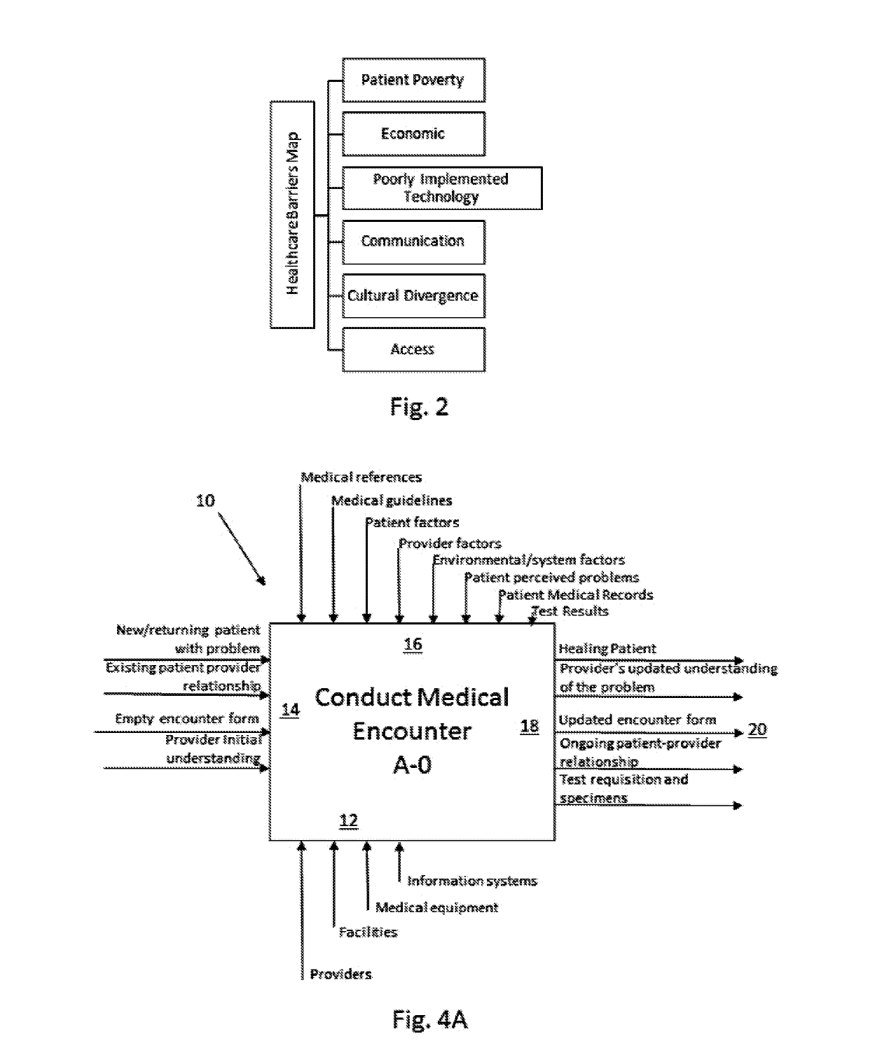

Healthcare is a uniquely human endeavor that begins with a conversation between the patient and provider in order to establish a trusting relationship, the exchange of sensitive information, and the interactive interpretation of that information in order to provide comfort and treatment. Information is the basic currency of the encounter. To understand the interaction more fully, the adapted Wickens model of human information processing is shown in FIG. 3 for reference.

It is important to recognize the human factors aspect of physician/patient communication. Both parts of the conversation exhibit cognitive processing of sensory data which in turn becomes neurologically encoded information. The human vulnerabilities and errors are well categorized by James Reason. Failure to understand personal variances and human factors limitations leads to broken expectations and miscommunication throughout the current medical healthcare process.

In patient-centered care, patient preferences shape the menu of care options. The provider cannot force people to do things against their will or beyond their financial means. The treatment decision is an informed negotiation. Often the best choice to pathway (such as surgery) and pharmaceutical are passed over due the patient aversion of side effects, disruption of work/family schedule, out-of-pocket expenses, etc.

### an Electronic Medical Record in Itself is not the Solution

A better record keeping system in itself is not the renovation required to boost quality and usability for the patient and their families. Most healthcare electronic medical record (EMR) systems are legacies of computerized billing systems and contain the flaws of an aged software architecture that has a billing system as its core. It is the inventor's insight that a more rational approach is instead to put the healthcare process at the core of the record-keeping system. The EMR should be considered just another instrument in the physician's black bag and not the controlling factor.

The inventor's further insight is that an integrated suite of services needs to be created to support the physician/patient interaction. The current clinic environment is that in which the physician's functions are disjointed and distracting. In this current clinic environment, the physician's expertise cannot be adequately focused upon listening to the patient's problems, providing adequate education, and eliciting patient engagement in order to prevent and combat the chronic diseases so prevalent in America. Time constraints and economic pressures have only worsened the clinic environment.

### Renovation of the Patient Physician Encounter and Relationship

The inventor has crafted a new method that places “the patient” at the center of this interaction rather than “the billing system”. Placing the patient central in this model of care, improves patient engagement, thus nurturing the opportunity for increased autonomy. This in turn, opens the opportunity by which the patient takes on both more responsibility and more accountability for their health. By implementing this model, the patient not only becomes more engaged in their care, but also more educated and better able to manage their own habits which impact their health.

Nonetheless, the physician cannot do it all. The physician is the orchestrator of the healthcare team that coaches the patient to follow better habits and supports them through the treatment regimen of whatever disease entity arises. To provide this level of service, a broader and deeper team needs to be in place at the primary care level, which is the patient's interface and portal into the healthcare system. The inventor's dream of a multiple tier seamless care team is achievable through an enterprise management system (EMS) 172 complemented with an EMR 264 (see FIG. 5), to provide at all levels correct and consistent guidance for their patient contact/encounter. The encounter may take place in multiple venues: a phone call, office visit, telemedicine therapy session, procedure, or hospitalization. The healthcare team with the foundational Healthcare Toolkit 100 will be successful in supporting and carrying out their activities with the medical and informational instruments, which are described within, fitted to those tasks. Current software instruments are ill fitted to the task and their distraction ripples through the work environment necessitating workarounds and lost productivity.

Over the last five some years, Bauer Labs LLC (Bauer Labs) conceived, designed, and evolved the Healthcare Toolkit 100 design to maximize functionality and usability among different provider levels in order to create a cohesive and efficient healthcare team and environment. The technology of the Healthcare Toolkit 100 is used to glue team members together and organize activities that maximizes favorable patient outcomes and experience. From the beginning, the Healthcare Toolkit 100 was created to be an instrument that providers will use because it makes their jobs easier. Patients' needs and wants are the primary requirements for the device and system as a whole and thus makes the Healthcare Toolkit 100 patient-centered.

### Design Goals:

### the Human-Machine Systems (HMS) Driven Design

Aviation is a domain that demonstrates the superiority of HMS approach in an increasing quality, capability, and safety. Higher reliability industries use HMS approach as their standard for design and problem solving. Bauer Labs engineering team is expert in the HMS driven design approach and firmly believes it is what healthcare needs to evolve from a cottage industry to high reliability enterprise. The Healthcare Toolkit 100 design process at Bauer Labs employed this method throughout the three versions prototyped.

### IDEF0 Model

To improve a process one must understand it. IDEF0 modeling is an explicit and standard method to gain deep insight into a process. The first part of the development of this architecture consisted on mapping all the activities performed in a medical encounter from the viewpoint of both patient and providers.

IDEF0 is a modeling method designed to model the decisions, actions, and activities of an organization or system. In FIG. 4 is an IDEF0 diagram used to help create enterprise management system 172 to show data flow, system control, and the functional flow of lifecycle processes. The highest level of this diagram is the A-0 diagram 10. The A-0 diagram 10 describes the medical encounter process. During the medical encounter, the physician uses information systems 12—which include information from the architecture application designed in the Healthcare Toolkit—, medical equipment, facilities and providers to generate a complete encounter form 20 of various sets of encounter forms 172 and work tables 166 (see FIG. 1B) for the encounter/visit.

The physician uses patient information 14 including the existing patient-provider relationship and the provider initial understanding of the problem in order to guide the process to generate the complete updated encounter form 20. The Healthcare Toolkit output 18 of this process includes an updated complete updated encounter form 20; any tests requisitions necessary, and a healing patient as well as the provider's updated understanding of the problem and an improved ongoing patient/provider relationship.

The controls 16 that regulate this whole process are medical references and guidelines, patient, provider and system factors, patient's perceived problems, environmental system factors, patient medical records and test results in order to generate the complete updated encounter form 20.

### Failures Mode and Effects Analysis

After completing the IDEF0 diagram, a failure modes and effects analysis (FMEA) was created. The FMEA is a method to identify potential failure modes within a system for classification by the severity and likelihood of the failures. Eight activities were analyzed. From this analysis, some requirements for the design of the enterprise management system 172 were derived. Table 1 shows the activities and the potential failure modes associated with each activity.

TABLE 1

| Activity | Potential Failure Mode |
|---|---|
| A1: Collect information | Information is not recorded |
| A13: Identify customized encounter | Information does not provide insight of |
| form | patient's circumstances |
| A14: Collect HPI | Access wrong patient's record |
| | System does not have patient |
| A15: Conduct examination | User retrieves wrong patient's |
| | information |
| | User retrieves wrong information |
| | User does not know how to retrieve |
| | patient's information |
| | Time and data is not correct |
| A16: Document Collected | Incomplete information to make |
| | diagnosis |
| Information | Information recorded is wrong |
| | Information is not recorded |
| A2: Conduct diagnosis | Incomplete information on encounter |
| A3: Treat patient | Incomplete information on encounter |
| A4: Plan follow-up | Incomplete information on encounter |

### Design Requirements:

The development of requirements for the Healthcare Toolkit 100 helps to clarify the expected features necessary to adequately develop the concept so that it meets expectations as outlined by clinician interviews and focus groups. Specific requirements were derived from the IDEF0 model and the FMEA. A set of human factors guidelines used along with the aforementioned can be found summarized in Appendix 1. Rigorous cataloging of requirements improves the likelihood of successful design implementation. The current list of requirements is lengthy and therefore can be found summarized in Appendix 2.

### Evolution of the Design

### Phase I Prototyping

The initial design effort was a development of the concept as embodied by the technology available between 2003 and 2005. Clinical workflows were analyzed in accordance to processes described in best practice. This consisted of group meetings to construct initial IDEF0 models of healthcare activities and in hospital/clinic observation of actual clinical teams practicing medicine.

### Phase II Prototyping

Secondary design refined the software architecture and integrated medical decision making support and medical content to support operation during a common clinical encounter. IDEF0 model was constructed to reflect the clinical encounter process. FMEA was accomplished using this model. From both IDEF0 model and FMEA, a set of usability and functionality requirements was derived. IDEF0 model enables creation of a new patient encounter focused enterprise management software (EMS) architecture based on the Nexus design already patented by Bauer Labs, U.S. Pat. No. 7,966,269 B2, Intelligent Human-Machine Interface, issued Jun. 21, 2011, which is herein incorporated by reference.

Further research on decision support in diagnosis functions helped Bauer Labs to expand the potential to achieve meaningful use by the clinician. Wireless medical instrument designs were further refined to be more graceful and ergonomically correct.

### Phase III Prototyping

The patient interface to capture clinical data was further developed. Further iterations of visually depicting patient data to aid in diagnosis were explored. Treatment decisions and the implementation interface was further developed. A better prototype was developed using App cooker software to demonstrate the potential functionality of the Healthcare Toolkit 100 design. Integration with social media was explored and to have education resources available via social media and medical databases available to the clinician at the appropriate juncture of the encounter.

Medical informatics experts at Bauer Labs explored the interoperability, security, and HIPAA requirements (The Health Insurance Portability and Accountability Act of 1996 (HIPAA; Pub.L. 104-191, 110 Stat. 1936, enacted Aug. 21, 1996). Systems engineering requirements were further refined to enhance usability and functionality.

### The Road Ahead

The Healthcare Toolkit 100 may use a modified Nexus multi-agent architecture, and may include one or more electronic tablets 110, such as patient tablets and clinician tablets, EMR servers, and secure online portals that facilitate the operation of healthcare teams during a formal usability study. The Healthcare Toolkit 100 creates different encounter forms for various stages of the encounter as input/output forms and responsive work tables.

A summary of the functionalities of the enterprise management system 172 are:
Creates a customized portal for all users/stakeholders identified above
Patient reports of:
   Test results
   Diagnosis (including problem list)
   Educational info. & links
   Concise patient history tracking, storage, and data filtration
   Wellness map & wellness dashboard
Community health & epidemiology work table
Diagnosis work table to aid the provider organizing & analyzing information to create a Differential Diagnosis. Graphic representation of clinical information combined with access to medical databases and search engines.
Treatment work table to aid the provider and patient in sorting through treatment options to formulate a workable Treatment plan. Graphic representation profiling treatment option effectiveness, costs, risks, and side effects data combined with access to medical databases and search engines
Customizable interface with all mentioned stakeholders
Operations workflow is coordinated based on a process model
Can link a multitude of healthcare providers & supporting staff into a well-coordinated team effort
Patient centered agenda: Interface usability is customized to increase patient awareness of the health status/problems/progress of the encounter
Accommodates lean management (Capture real value added and non-value added activities in healthcare activities)
Measure patient satisfaction
Provide portal for patient driven quality improvement
Track patient emotional state & metrics such as anxiety and depression (In addition to functionalities addressed by the requirements identified in the project summary document in Appendix 2)

FIG. 4B is an example schematic drawing illustrating the physician “mental model” of the patient-centered medical encounter flow 200 and its interaction with other elements within the description. A patient begins at the client intake and ID station 215 or alternatively in emergency situations, a triage station where the patient if not formally identified is still given a unique ID so he/she can be tracked through the encounter. Where available, the patient's prior history and understanding of their problem is entered along the provider's initial understanding of the problem and its urgency. Depending on the situation, appropriate interview questions may be asked and any patient existing diagnosis and medical records are retrieved from the patient's database 176 within the EMR 264 database. The EMS 172 may include an interview agent 453 which creates the appropriate encounter forms 174 for the client intake and ID station 215.

The patient bottleneck to obtaining health care history is alleviated by placing in the history collection form in an electronic tablet 110 or other device such as a cell phone information from the EMR 264 database that is readily available to be edited by the provider or the RN at the intake station 215 or interview portion of MMD stations 460. Preloading information that is later verified for accuracy will speed patient/client flow.

Based on the information received from the intake agent 453, the HCT system agent creates the remaining encounter test requisitions, worktables 166 and encounter forms 174 and guides the patient and providers through the appropriate sequences coordinating with other patients being processed to ensure efficiency and effectiveness of the process. Physical exam agent 458 provides the protocol for worktables and encounter forms to have a physician perform an physical exam of the patient. Patient system agent 451 keeps track of the patient information entered using the patient ID 122 to ensure that proper records are recorded and stored in the appropriate records in one or more databases, such as community database 482 or clinic database 481. Patient system agent 451 also keeps track of the patient at various waypoints along the patient-centered medical encounter flow.

Assuming the patient requires tests to be taken, the patient is directed to one or more medical measurement stations 150 each with guidelines and a patient-centered work table 460 created by the HCT system agent 450 based on a physician provider's initial understanding of the problem. If a particular test requested cannot be performed by the HCT 100, then the patient may be referred to other provider(s) 360 to have the tests done and the results returned to the EMS 172 for incorporation into the medical encounter complete form. Each medical measurement device worktable is customized to the patient, provided, and controlled by an appropriate MMD agent 470.

After the patient has had all of the requested tests performed, a physician or other trained diagnostician then reviews the patient's prior history, the patient's medical record 176, any appropriate references 485, guidelines 484, global databases 483, clinic databases 481, and a community database 482 kept by the HCT 100; helpful for detecting trends, common illnesses, environmental contamination, etc. . . . . All of these inputs and possibly others are used by the HCT system agent 450 along with a diagnostic agent 457 to create a patient-centered diagnosis work table 463 to assist and guide the physician or diagnostician to a proper differential diagnosis. The diagnostic agent 457 may include a debiasing memory routine to ensure that various cognitive biases are guarded against and that as much information as needed is presented during the diagnosis. The diagnostic agent 457 creates the appropriate work tables 166 and encounter forms 174 based on the patients information gathered during the encounter and the external databases, references, and guidelines.

One feature of the HCT 100 is that the need for front-end coding by physicians currently driven by billing or insurance systems can be alleviated or remediated by having the diagnostic agent 457 preload the billing or insurance checklist based off the diagnostic work table 463 results and automatically submitting or having the physician or other provider review the checklist before submission. This approach reduces the physician or clinician bottleneck in capturing data in ways that are not ideal such as checkboxes, obscure codes, and encounter templates provided by third parties or the billing office.

Once the diagnosis is settled upon, the physician or other specialist provider is presented with a treatment work table 467 which is created by a treatment agent 455 based on the diagnosis of the patient's problems and the options available from the clinic database 481, external global databases 483, the HCT community database 482 and any guidelines 484 and references 485. The physician or other specialist provider works through the treatment work table as described below and the results are recorded in the patient's medical record 176 in the EMR 264 along with the diagnosis. Additionally, a record of the encounter may also be saved in the HCT community database 482 to help assist in the diagnosis and treatment of others in the community and to help spot common illnesses and trends. This HCT community database 482 allows for the creation of a community health & epidemiology work table 464 which the clinic management, physicians, regulators, insurers, community health, researchers, and other medical community professionals can access to view results on the population served by the HCT 100. For instance, after the HCT 100 is used in an emergency response scenario, the overall results can be quickly retrieved and analyzed to see what common problems exist or how the response could be improved in future situations. The community database 482 also allows for the creation of ‘virtual’ or ‘bricks and mortar’ support groups to further help the patient engagement, education, accountability, responsibility, and satisfaction.

When the treatment plan is complete, the patient is directed to an out-brief station 225 where he/she is given or presented with copies of the test results, prescriptions, therapy choices, education information, follow-up appointments, referrals, and billing. The information may also be electronically transferred to another provider of the patient such as with Continuity of care Documents (CCDs) for updating other electronic medical record databases, or made available on the web, email, or patient electronic device such as a phone, tablet, or personal computer. For instance, using Direct Messaging protocols with state, regional, or local health information exchanges (HIEs). Another standard is Health Level Seven (HL7). HL7 provides a framework (and related standards) for the exchange, integration, sharing, and retrieval of electronic health information. The 2.x versions of the standards, which support clinical practice and the management, delivery, and evaluation of health services, are the most commonly used in the world.

Patient records may be transferred with secure messaging protocols including appropriate encryption as required by various laws, codes, protocols, and standards. At the end of the patient-centered medical encounter, the patient will be more engaged, have more education about their problem and its treatment, better responsibility and accountability in following the treatment plan, and an overall higher level of satisfaction. The out-brief station 225 may also include a survey or other form to gather the patient's satisfaction with the process including results and to note any problems which may have been encountered so the patient-centered medical encounter process can be continually improved.

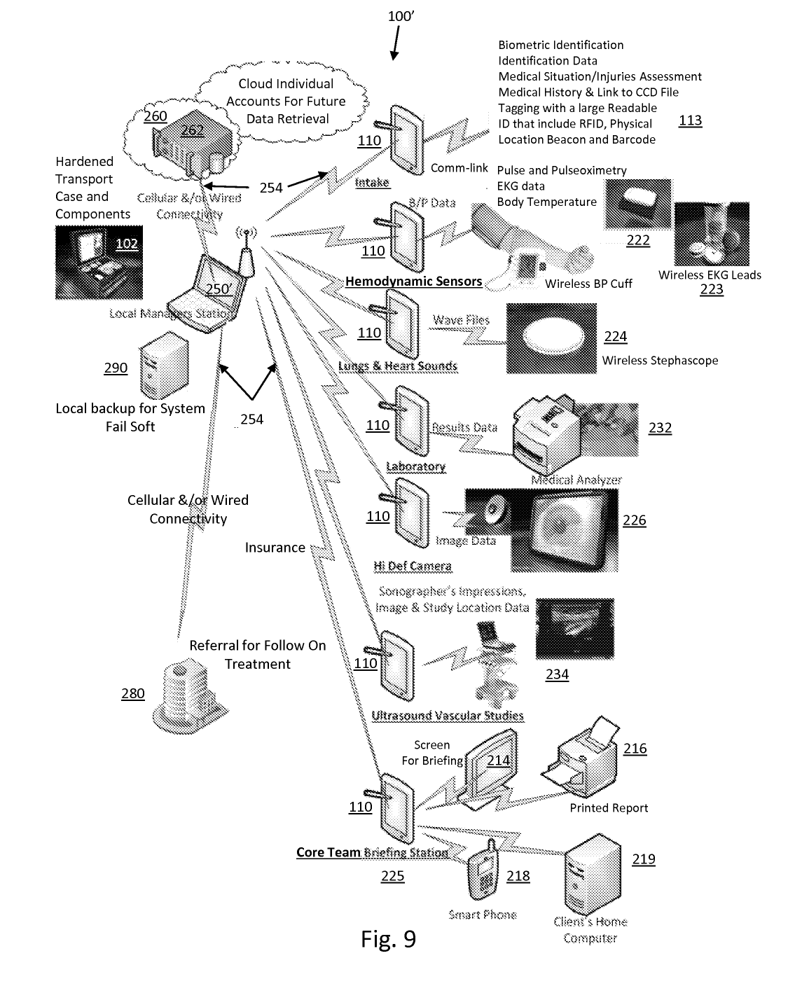

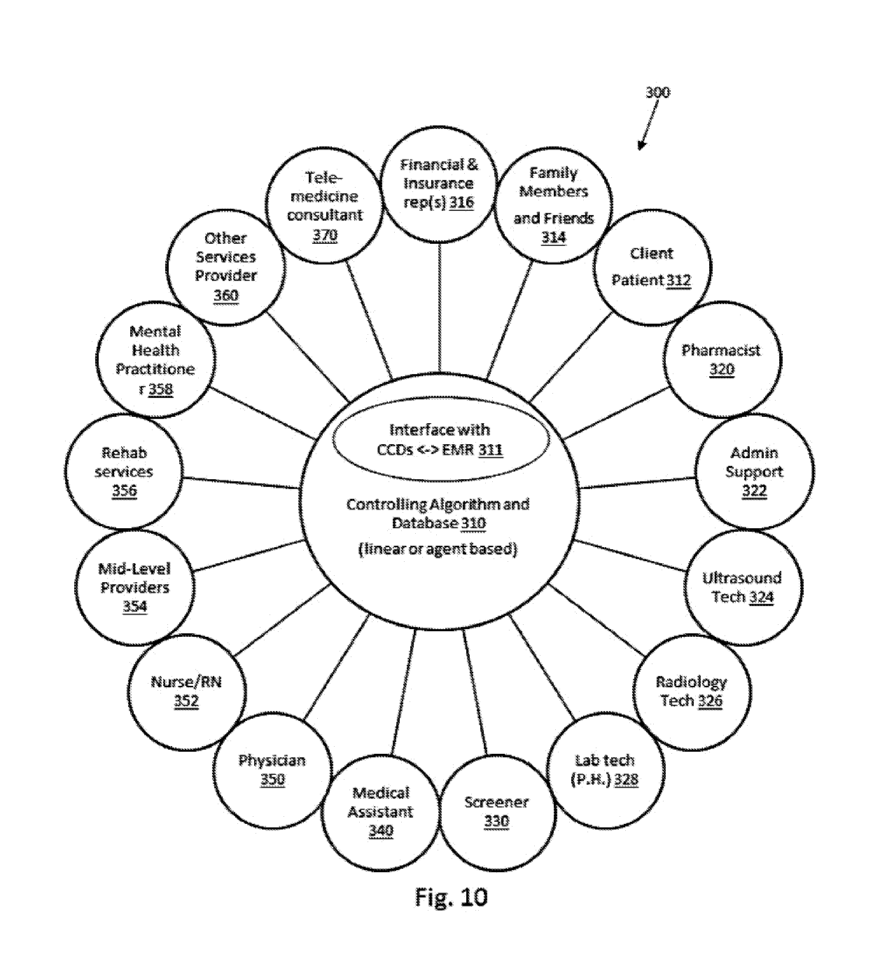

The enterprise management system 172 is part of a controlling algorithm 310 (FIG. 10) which may be implemented in many different software based or software/hardware forms. For instance, the controlling algorithm may be implemented as a linear program or as a combination of various objects or agents coordinated by a system agent in a layered agent model. Further, some agents may be sub-agents of other agents or separate modules which can be accessed independently. Various ancillary functions may be carried out by one or more function agents 440 (FIG. 11) under the control of a HCT system agent 450. Further, the EMS 172 may be implemented on a server/client architecture where the “server” is a local manager's computer that coordinates the activities of each of the various “client” medical measurement, intake, diagnostic, treatment, and out-brief stations for several patients in parallel. In other examples, EMS 172 is a distributed software architecture in which one or more of the various system agent 450 or function agent modules 440 are implemented as APIs on separate computing systems but linked via networking or other communication channels. In other examples, EMS 172 may have particular system agents loaded and operating on respective electronic tablets 110 in order to improve responsiveness and autonomy in difficult wireless communication areas. In some examples, the EMS 172 is local to a single computer, electronic tablet 110, or other device and configured to control all of the tests and other stations such that the HCT 100 is a fully contained system, such as for use as a physician's “black bag” or as a kit for emergency response situations. More specific detail follows in the accompanying description below.

### Use of Healthcare Toolkit in Enterprise Settings:

### Configuring the HCT System for Population Screening Operation

The Healthcare Toolkit can link multiple providers and patients together into a single enterprise such as community health screening. Typically, a screening operation must be mobile since the venue changes as the screening project reaches out into the community to serve the clients in convenient locations, such as shopping malls, churches, office lobbies etc. the screening operation serves large numbers of clients over a short time and the generated data must be placed in the correct patients information account despite multiple clients being screened at one time in multiple screening stations. Misplaced or incorrect data can be disastrous. And yet the overall workflow of the operation must run smoothly and quickly. The demands of such an operation often overwhelm manual data entry. If such an operation has connectivity to outside educational resources, client's cell phones and email, outside providers and clinics it can function beyond simply generating physiologic screening data for the moment. The Affordable Healthcare Act (ACA), the Health Information Technology for Economic and Clinical Health Act, (HITECH Act) (enacted under Title XIII of the American Recovery and Reinvestment Act of 2009), and HIPAA revisions demand interoperability among electronic health records and an electronic support system for the screening enterprise will allow it to integrate more fully into the healthcare system as a whole. In fact, we believe it will be a useful and strategic portal for many to gain access into the healthcare system.

### Health Care Toolkit in Clinical Setting

FIG. 5 is an illustration of a patient centered Healthcare Toolkit (HCT) 100 in a clinical setting. The HCT 100 includes a local manager station (LMS) 250 having one or more wireless interfaces 252 to wirelessly connect 254 with one or more information system servers 262 which stores one or more individual patient's Electronic Medical Record (EMR) 264 in a nearby or remote location such as a cloud computing system 260. In some examples the LMS 250 may be one of the electronic tablets 110 configured to operate as the LMS 250. In other examples, the LMS 250 may be a notebook computer, desktop computer, server-client system, or equivalent. In some examples, the LMS 250 may have a wired, optical, or other physical network interface link to be able to connect to the server 262 with the EMR 264. Also, the one or more servers 262 may be connected via the Internet, or implemented and organized in one or more cloud computing systems 260. The LMS 250 may be wirelessly or otherwise physically connected to one or more information systems such as insurance databases 270 to get approval for various medical services or treatment as well as for uploading results and billing information for payment. LMS 250 may also be wirelessly or otherwise physically connected to other information systems 280 at medical centers, physician offices, treatment facilities, or other physiological referral offices.

LMS 250 is wirelessly connected 254 with a set of one or more electronic tablets 110 or other mobiles devices such as cell phones, PDA, mobile computers, phablets, and the like. One of the electronic tablets 110 may be a client or patient intake tablet, such as intake interview station 215. This intake interview station 215 may also include an assistant intake terminal 113 by which a medical helper professional can assist a patient to help collect intake data, including the patient self-knowledge of their problem(s).

In this example, a set of LMS 250 each connect wirelessly to a respective set of medical measurement devices (MMD) 150 to create a set of medical measurement stations 221 to collect at least one of a physiologic, radiographic, or bio-chemical set of data. For instance, a blood pressure station may use a wireless blood pressure cuff 222 which records the systolic and diastolic blood pressure readings of a patient and transmits such data to the respective wireless tablet 110.

Various medical measurement stations 221 include the intake interview station 215, out-brief station 223, a blood pressure and pulse station 222, lung and heart sound station 224, lab test medical analyzer station 232, image station 226, sonographer station 234. Sonographer station 234 can upload images, test results, and preliminary findings to the station's electronic tablet 110 for further upload to the local manager's station 250 or it may bypass the electronic tablet 110 and upload the data to the local manager's station 250 directly.

LMS 250 includes an enterprise management system (EMS) 172 (see FIG. 1B) that uses a physician “mental model” of exam flow to create a set of work tables 166 and a set of patient-centered encounter forms 174 (see FIG. 1B) for each respective portion of the patient encounter. The LMS 250 depending on the patient self-knowledge, patient EMR 264, and physician input will create any test requisitions for each of the set of MMD 150 at appropriate medical measurement stations 221. The LMS 250 also creates and provides correct and consistent guidelines for the respective operators of each of the set of electronic tablets 110 at the appropriate medical measurement station 221.

The EMS 172 may use as control inputs medical references, guidelines, system factors, and information from the EMR 264 of the patient, including patient factors, provider factors, patient perceived problem(s), medical records, and test results to create the patient centered encounter form. Each of the electronic tablets 110 may be configured by the EMS to allow an operator of any of the medical measurement stations 221 to track the emotional state and metrics of each patient, such as anxiety and depression. The EMS 172 may also be configured to create a treatment work table 166 with various options, costs, possible side effects, and provide access to medical databases and search engines. In some examples, the EMS 172 may be configured to provide a recovery solution for an operator of the medical measurement stations 221 when an error occurs. Such recovery may include restarting the test, just redoing those portions of the test in which an error occurred, referring the patient to another medical measurement station 221 with a similar MMD 150, or referring the patient to another provider and later electronically retrieving the results for entry into the encounter form.

Each EMS 172 encounter form 174 at respective intake station includes an interview subsystem 453 (see FIG. 11). The interview subsystem 453 collects and integrates the patient medical information into the respective patient EMR 264. The interview subsystem 453 can connect with the information systems noted previously to upload and download patient medical record information, including EMR 264. During the interview, the new patient information is integrated into the patient's medical record along with the provider's updated understanding of the patient information. The interview subsystem 453 also provides a reminder to the operator to collect the patient's chief concern(s) or complaint(s) and the provider's perceived urgency of the problem(s) along with the patient's self-knowledge of their problems. The interview subsystem 453 creates an agenda for the interview questions and reminds the operator to ask open ended patient-centered interview questions and closed ended doctor centered interview questions. The interview subsystem 453 collects and integrates existing diagnosis from the patient's medical records and EMR 264. Further, based on the various input, the interview subsystem 453 characterizes the patient's symptoms and shows which questions the patient responded to for the physician's interface in the encounter form. In terms of usability, the interview subsystem 453 completely allows for the recordation of visual, auditory, and written information and is usable by colorblind people. Further, the interview subsystem 453 has consistent color and symbol use. During the interview, the subsystem allows the physician to update medical records and to enter and annotate the data. A chronology of symptoms and other diagnostic information is depicted on the electronic tablet 110. The interview subsystem 453 provides a reminder for the physician or other operator to ask correct test requisitions based on the various input. Finally the EMS 172 uses the integrated information from the interview subsystem 453 to create the appropriate physical exam and diagnosis process encounter forms.

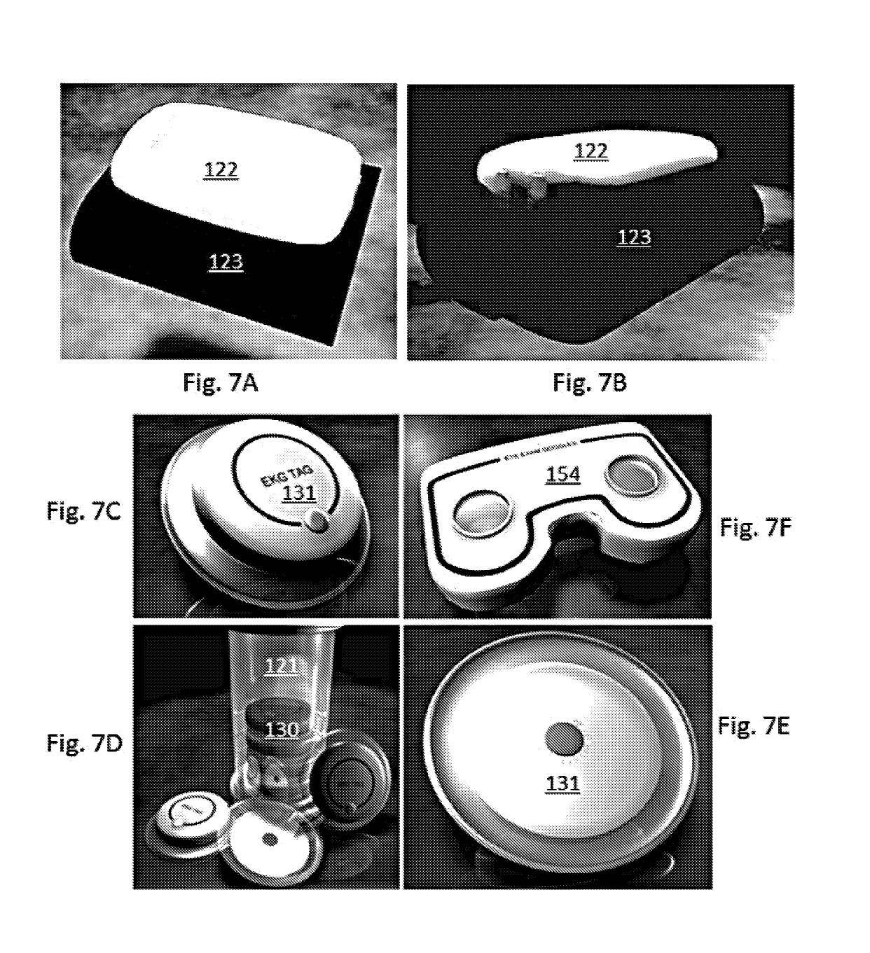

The EMR 264 in generating the encounter creates as set of medical measurement stations 221 encounter forms on the electronic tablet 110 using a physical exam sub-agent 458. During the physical examination of the patient, the operator of the electronic tablet 110 can communicate with the EMR 264 as well as allowing the patient to access their medical records. The EMR 264 can be updated with the exam data and various findings. If the electronic tablet 110 or local manager station 250 cannot access the Internet or other appropriate network, the exam data is still recorded at either the electronic tablet 110 or local manager station 250 until an Internet or other network connection is re-established. The physical exam sub-agent 458 is able to record and recognize an operator's voice sound. Using an electronic wireless stethoscope 124 (see FIGS. 1A, 1B and 7G, 7H), the patient's heart and lung sounds can be listened to an recorded along with the physician or operator's audio or written comments (including handwritten notes via camera image or using a stylus device on the electronic tablet 110), particularly even when the physical exam is done in the presence of noisy environments.

The LMS 250 may also, when configured to access the EMR 264 of the patient or via an offline process, create a Continuity of care Document (CCD) file based on the results of the patient-centered encounter forms for import into the EMR 264 of the patient. The CCD specification is an XML-based markup standard intended to specify the encoding, structure, and semantics of a patient summary clinical document for exchange with various EMR 264.

The EMS 172 may also configure particular medical diagnostic stations such as high-definition (HD) camera device 126 to collect pictures or other data to send to other specialists additional information of the physical status and health of the patient not evaluated by the HCT 100, such as pictures of teeth, moles, warts, burns, and abnormal skin coloration as just a few examples.

The HCT 100 may have a medical measurement station 221 with an electronic tablet 110 configured to act as an out-brief station 223 which may also include a separate screen 214 and/or printer 216 for viewing the results of the various tests and diagnostics as well as to collect patient satisfaction with the encounter. The out-brief station 223 may also provide the patient test results and basic recommendation for follow-up such as new appointments or referrals to other providers. The out-brief stations 223 may also provide a patient health dashboard, a medical problem list, educational links and other material such as support group information and if required, appropriate referrals for follow on care.

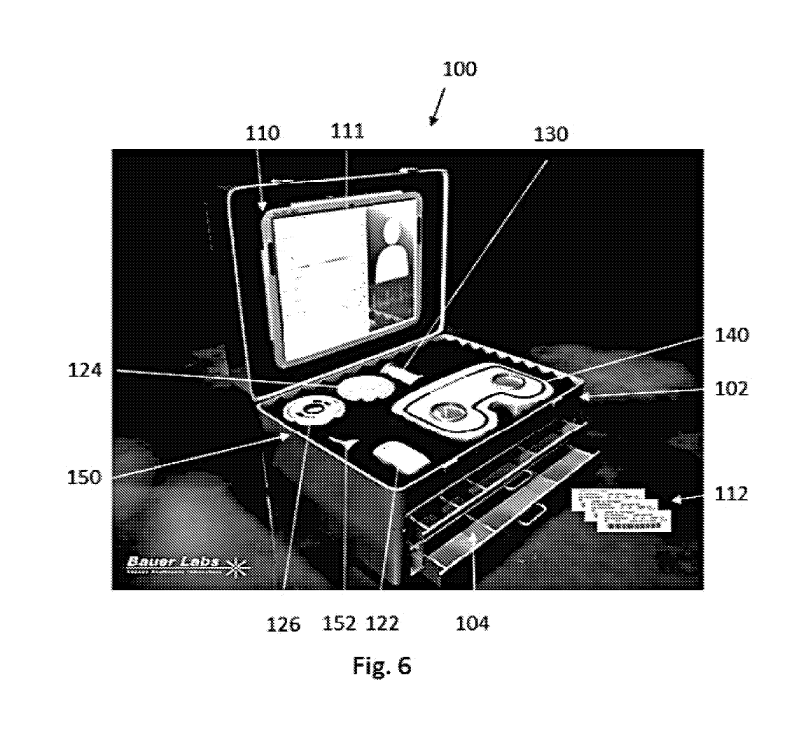

FIG. 6 is a Computer Aided Design (CAD) drawing of a Health Care Toolkit (HCT) 100 in one example following the design principles previously discussed. The HCT 100 may include a hardened and protective case 102 to hold components of the toolkit for safe transport and may include one or more drawers 104 for additional items. The HCT 100 includes a set of identification (ID) devices 112 which are used to uniquely identify each of a set of patients. The set of ID devices 112 may be stored in one of drawers 104 or be created and attached to the patient using an auxiliary device, such as a bar code printer. The HCT 100 also contains a set of electronic tablets 110 which are used to help an operator wirelessly control a particular one of a set of medical measurement devices (MMD) 150. The set of electronic tablets 110 includes one or more tablets depending on the application and includes at least one tablet configured to operate as a patient intake tablet. The electronic tablets may have one or more software programs to allow for control of the set of MMD 150. The set of MMD 150 may include one or more devices from the set of physiologic, radiographic, and biochemical data. The physiologic-type MMD 150 may include wireless blood pressure monitor 122 to capture and calculate the blood pressure and heart rate and a wireless stethoscope 124 to listen to and record heart and lung sounds. The radiographic-type MMD 150 may include a wireless HD camera 126 with a resolution of at least 1900*1200 to capture pictures such as dermatologic images or images and videos of the ears with an ear adapter 152 (FIGS. 1B & 7L). Other radiographic-type MMD 150 include wireless EKG probes 130 to capture and record the electrical activity of the heart, and wireless eye exam goggles 140 to capture and record images and videos of the eyes. The biochemical MMD 150 may include one or more medical analyzers 232 (FIG. 5) such as wireless blood glucose analyzers, wireless cholesterol analyzers, blood chemistry analyzers, and wireless urine analysis samplers. In some examples, the biochemical MMD 150 is a wireless link to a separate laboratory database. For instance, the encounter form can provide access to the copies of reports for test results issued by the MMDs 150 and medical labs.

Each of the various devices or elements (equipment) of the HCT 100, including the electronic tablet 110 and MMDs 150 are designed ergonomically to ensure operation in both typical clinic situations and emergency medical situations. For instance, the equipment is designed to be portable and handheld with means for grasping, handling, and carrying and weight less than one pound and are smaller than 14″×9″×3″. The corners and edges of fixed and handheld equipment which are exposed to bare skin of the operators are rounded and are temperature controlled to not cause epidermis/dermis interface temperatures to exceed a heat pain threshold limit of 44 deg. C. (111.2 deg. F.) nor drop below a cold pain threshold limit of 10 deg. C. (50 deg. F.). The equipment are capable of continuous and autonomous operation for no less than 2 hours. To prevent accidental damage, the various equipment are resistant to impact from dropping or bumping. To prevent unnecessary or inadvertent spread of infections or other diseases, the equipment is designed to be easy to clean and have a germ-resistant surface. In addition, the equipment when in use is designed to guarantee the safety of the operators (physician, patient, other operators, and maintenance staff).

FIGS. 7A through 7L are CAD drawings illustrating the ergonomically designed approach used for HCT 100 in one example. FIGS. 7A and 7B are a pictures from two different angles of a wireless blood pressure monitor 122 with a cuff 123 for wrapping around a patient's upper arm. The body of the blood pressure monitor 122 has rounded edges and is easy to clean. FIGS. 7C, 7D, and 7E are pictures of a portable EKG device 130 having a plurality of EKG tags 131. FIG. 7C illustrates the rounded nature of a top-side on one EKG tag 131 and the lack of sharp edges yet still having a shape able to be grasped easily and easy to clean. FIG. 7E illustrates the reverse side of EKG tag 131 and the rounded nature of the surfaces which interface to the patient's chest and other areas which again are easy to clean. FIG. 7D illustrates an EKG container 121 that can store the plurality of EKG tags 131 to have a full set for EKG device 130. Even the container has rounded surfaces and is easy to clean and clear to determine quickly if all EKG probes are present. FIG. 7F illustrates a portable eye-exam goggle 154 which can be used to observe and record issues with the patient's eye, such as shown in FIGS. 7I and 7J. Note that all the edges and surfaces are rounded and easy to clean. FIGS. 7I and 7J illustrate electronic tablet 110 having a display screen 111 with views of high-resolution photos 153 of the patient's eye. The electronic tablet 110 also has rounded surfaces and is easy to clean. FIGS. 7G and 7H are different views of an electronic stethoscope 124 with a strap 125 for holding the stethoscope 124 to the patient and a smooth rounded surface 127 for contacting the patient's body. FIG. 7K illustrates a high definition (HD) camera device 126 that is rounded and easy to clean. The HD camera device 126 may have an accessory adapter mount 129 to allow an adapter 152 in FIG. 7L to be used to view ears, noses, and other body areas with small cavities. All devices in FIGS. 7A-7L operate between the cold threshold and the heat threshold of pain temperature ranges noted above.

Moreover, the encounter forms generated by the EMS 172 are ergonomically designed to operate in an “intuitive” manner requiring little if any written instructions. The menus and form interfaces are easy to navigate and the graphics and icons make the operations understandable. The encounter forms provide mechanisms to prevent mistakes that may occur during operation and informs the operator when it is not working properly or needs calibration. Further, the encounter forms provide feedback to the physician or operator with regards to their actions and the consequences of them.

The encounter forms may exploit top-down processing where appropriate and may exploit redundancy while using discriminable elements. To help in the intuitive use, the encounter forms exploit the principle of pictorial realism. To help ensure that data is recorded in the appropriate medical record the encounter forms present the patient' personal information on all pages and allows for the reading of the ID devices 112 to confirm identity. To reduce information access cost, the encounter forms provide the patient's medical information in all pages in at least text and photo formats.

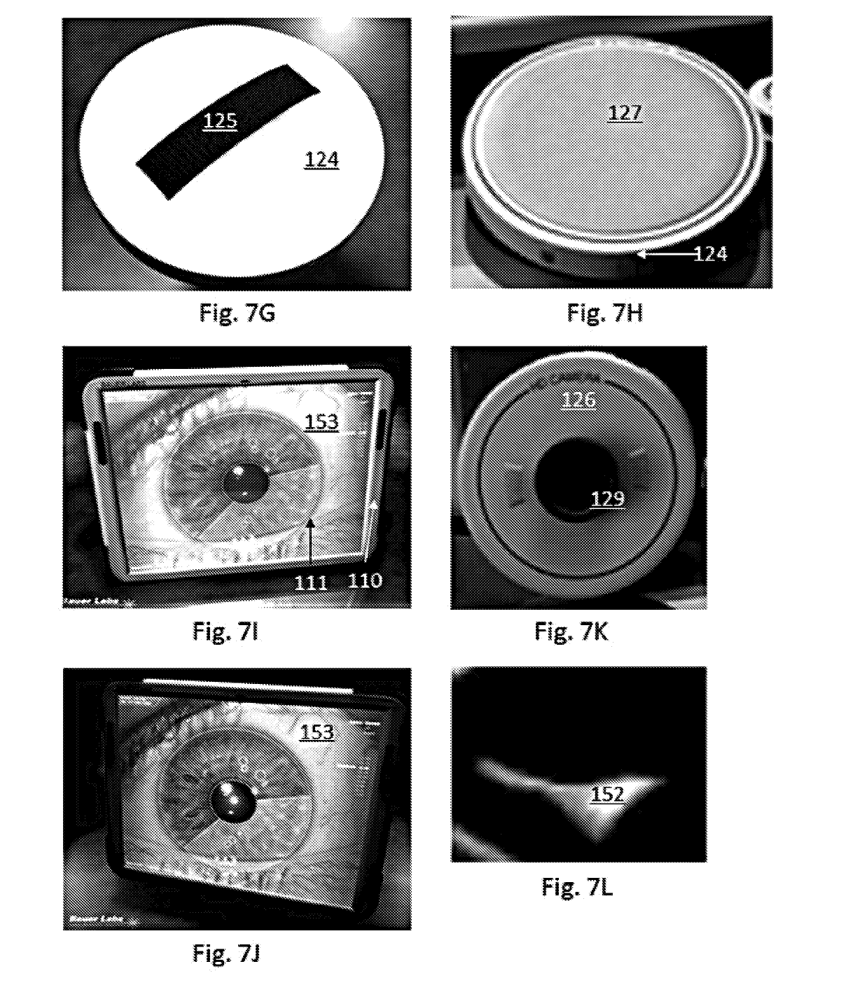

FIGS. 8A and 8B are example encounter forms 174 from HCT 100 illustrating the ergonomically design elements with the patient identification 127 in the upper right corner. FIG. 8A is an encounter form for an EKG 130 with EKG test results 133 shown in lower right corner. FIG. 8B is an encounter form 174 for a treatment plan with the patient identification 127 in the lower left corner.

Referring back to FIG. 5, screening operations are comprised of a number of stations analogous to an assembly line that produces a useful product for the client—information, guidance and referral if appropriate. The first station is client intake form which gathers and may record some or all of the following information:
1. Name and address
2. Photograph
3. Contact information—phone numbers and email addresses but could include social media as well
4. Alternate contact information
5. Registering a biometric identifier—fingerprints, Iris map, voice recognition print
6. Registering for the service and setting up an electronic account to access information
7. Privacy contract
8. Current medical providers
9. Insurance coverage
10. Credit card or other payment modality
11. Basic medical history
12. Medication list
13. Allergy list
14. Social history
15. Family history
16. Review of systems screening
17. Measure height and weight

The Healthcare Toolkit 100 tablet(s) 110 may interface with a data entry intake station 113 (see FIG. 5) for the patient where the screener assists the client in providing the information required. This may possibly be a bottleneck and several screeners may be assisting individual clients simultaneously.

Next the clients flow through a number of medical measurements stations 221 in order to gather physiologic, radiographic and biochemical data on each individual screened within the program. The client presents to the screener who identifies them through their biometric data or barcode or RFID. The screener uses MMDs 120 with wireless links to the system in order to automatically upload the physiologic data into the clients' record. By using biometric or an assured method of identification, client mix up is avoided. The individual screener can edit and annotate data through their mobile tablet 110.

The final station is an out-brief station 223 where the client is given their test results and basic recommendations. The patient can be given educational material in electronic format via email or cell phone text message. Alternately information and educational data could be dispensed in a printed format. Referrals to healthcare providers and clinics could be made. A nurse practitioner or experienced RN can manage the overall operation from a laptop containing a large storage disk at local manager's station 250. This laptop would then link to the cloud which contains the specific programs for both the screener's tablets 110 and the local manager's station 250. In some examples, the local manager's station 250 may be implemented using one of the electronic tablets 110. The local manager's station 250 would have access to the web; medical education sites/downloads, local provider information, and links to supervising physicians. The link to the top cloud 260 could be via cellular connection or hardwired. At the end, the client will have a health dashboard, medical problem list, educational links, and/or material and where appropriate referrals to follow on care. If a patient already has a care provider the information will be sent directly by fax, email, or other electronics means such as web-based APIs. In order to achieve interoperability the system will generate a CCD file to import into their electronic health record. They will also have a mobile secure link to download the information on to their personal devices such as cellphone 218 and home computer 219. Billing for the service will be handled electronically as well.

### Healthcare Toolkit in Emergency Response Situations:

### Configuring the HCT System for Mass Casualty and Emergency Response Operation

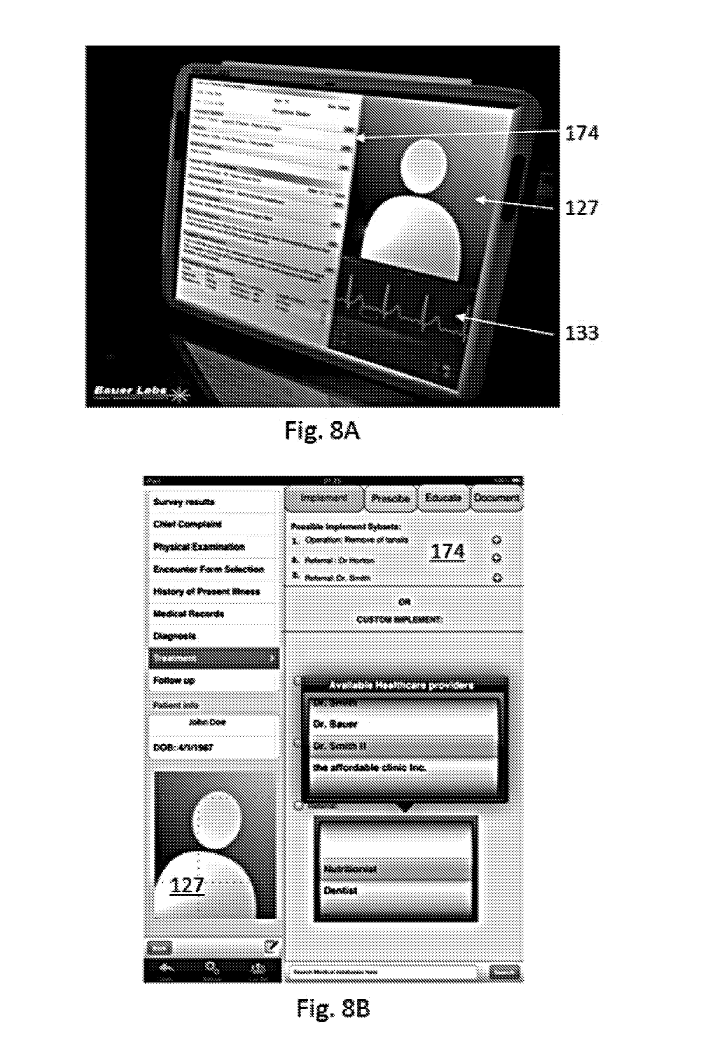

The recent bombings at the Boston Marathon again revealed the need for a suitable tool for first responders and medical teams to manage an unfolding disaster and reasonably triage and treat the victims. The Healthcare Toolkit 100′ can be adapted to that need. Refer to FIG. 9 for an overview. The emergency response configuration would be based on a process model crafted specifically for the situation and typical needs of the response team. Many response kits may have an EKG station 223 with wireless EKG device 130, a hardened case 102 and a local ‘fail safe’ backup 290.

In military applications, the carrying cases 102, and component electronic devices (tablets, etc.) 110, 150 can be hardened against magnetic pulse effects and physical abuse typically encountered in the field. The various component parts would have protective cladding and cases to prevent breakage during harsh conditions. Further, the various function agents can be modified to operate with the Department of Defense's AHLTA system which follows the Composite Health Care System (CHCS) upon which it builds a record system for all military venues. AHLTA system is now being renovated by incorporating outside vendor's EMR's. HCT 100′ may access AHLTA's typical data entry portals (CCD and a HL7) similarly to commercially available EMR's. The Armed Forces Health Longitudinal Technology Application (AHLTA) is the electronic medical record (EMR) system used by medical providers of the U.S. Department of Defense (DoD) since its initial implementation in January 2004. It is a services-wide medical and dental information management system. (According to the DoD, “AHLTA” is no longer considered an acronym, but is rather the system's only name.)

Teams of responders, each with their own specific skill sets can be coordinated by the disaster manager to effectively triage, treat, and arrange transport for further treatment by the response manager. Given the wireless instruments available to integrate into the system, a single responder could provide a spectrum of services or could be focused to one particular task. The system is designed to leverage the various skills of a single provider as well as coordinate the network of activities required for effective disaster response. A strong point of this system is real time coordination of a team of responders. The response manager's station 250′ (a version of local manager's station 250), typically a laptop, has an ancillary computer with robust storage 290 to act as a backup and a provision for ‘fail safe’ if indeed the system operation is compromised. This fail safe option has the ability to generate paper records, patient tags, and electronic transmission of information. The fail safe option is a memory buffer in case of connectivity problems. It provides the potential for save and forwarding of information when the connectivity problem is resolved. The response manager and clinical responders have the ability to access the victims EMR and to write CCD files to include:
Description of injury,
Pertinent past medical history,
Hemodynamic measurements,
In the field laboratory results,
Physical exam findings,
First response assessment
Treatment rendered.
Orders for treatment and care during transport to a receiving facility.

These records could include radiographic images, sonographic images, photos, and text reports. A dashboard of the patient's/victims situation would be available to the responder and the response/clinical supervisor. This information could also be forwarded to distant clinical facilities and crisis management teams.

Similar to FIG. 5, the drawing in FIG. 9 shows a multitude of responders providing identification, initial clinical evaluation, tagging the patient with identifying (visual, RFID, barcode and transponder) tags, numerous components of physical, laboratory & imaging examination, ongoing hemodynamic measurement, and small team management consuls. All these functions use mobile technology (wireless, Bluetooth, cellular) in order to form a medical care network around the victims of the event. In turn, the real-time information generated by this network will aid the providers in coordination of their response and overall effectiveness in interfacing with resources outside the location of the event. The present invention as system and network is a quantum leap forward compared to what is currently available.

### System Features

### Enterprise System Management:

An intelligent human-machine interface for a medical Healthcare Toolkit implementing the enterprise management system (EMS) 172 includes an interface shell 420 (FIG. 11), a system agent 430, and a function agent 440 and is provided in accordance with an example of the present invention. The system agent 430 includes one or more dynamic, knowledge-based software object sub-agents adapted to model and track the state of the patient encounter form. The function agent 440 is a set of various function agents adapted to model, track, and facilitate physician/patient encounter functions and interface to external resources as necessary. The interface shell is adapted to provide a hardware and software interface between the system agent 430 and the function agent 440. The intelligent human-machine interface is adapted to indicate key milestones in an encounter process.

FIG. 10 is an example block diagram of an intelligent human-machine interface 300 implementing the enterprise management system (EMS) 172 of FIG. 1B. The block diagram includes a controlling algorithm 310, either linear or agent based, and one or more databases to control the flow and execution of the Healthcare Toolkit (HCT) 100. Various patient-based inputs are received, processed, verified, and stored to help manage the well-engineered encounter process. The controlling algorithm and database 310 use inputs from several providers and return updated information back to them. Patient-based input includes the client 312 or patient themselves, their family members and friends 314, and their insurance or other financial representatives 316. Various medical providers include a pharmacist 320, administration support 322, in-take screener 330, medical assistants 340, the physician 350, RNs or other nurses 352, ultrasound technicians 324, radiology technicians 326, and other lab technicians 328. Also available as providers are remote providers such as other service providers 360, medical health practitioners 358, rehabilitation services 356, and mid-level providers 354. Also, when need be, the controlling algorithm 310 can request and receive information from a tele-medicine consultant 370. The controlling algorithm 310 may have an EMR interface 311 with one or more electronic medical records (EMR) and accept and create CCDs to create or update a particular patient's EMR.

In accordance with another example, the intelligent human-machine interface may include a layer adapted to connect to other intelligent human-machine interfaces of Healthcare Toolkits 100 through the internet to create a library of correct and incorrect diagnostic and treatment procedures with aims to facilitate machine learning.

An example of implementing the controlling algorithm 310 of the enterprise management system 172 is described below in FIG. 11 using a layered agent approach. Other methods and techniques for implementing EMS 172 are possible and are equivalent in structure and fall within the spirit and scope of the claims. First, some definitions are in order to help understand the method of implementation.

Agent as used herein refers to a computer program, subsystem, or module that has the ability to perceive, reason and act in an autonomous manner in both a reactive and proactive fashion. A common view of an agent is that of an active object defined by a specific bounded process, and with the ability to communicate with other agents. Agents may include one or more sub-agents or subsystems which may also be agents.

Autonomy as used herein refers to “under self-control”.

Knowledge-Base as used herein refers to the language to communicate assertion about the real world and provides the structure to logically store data and process that resemble the real world elements, interactions and their interrelationships. Each agent's attributes and methods represent a subset of the Knowledge-Base and the interactions and relationships between agents complete the overall Knowledge-Base.

Agent architecture as used herein refers to a particular method to build agents, so they can perceive, reason, and act autonomously among a community of other agents.

Architecture as used herein refers to the particular arrangement of data, algorithms, and control flows, which the agent uses to decide what to do.

Layered agent architecture as used herein refers to the particular structure in which each agent's functions are arranged to accomplish multiple types of behavior, such as reactive behavior, pro-active behavior, logic based, behavior, cooperative behavior, among others.

System architecture as used herein refers to the structure or organization of the components (modules), the manner in which these components interact, and the structure of the data that is used by the components.

Interface shell as used herein refers to hardware and software required to host the agents and to link those agents with the structural (physical elements) of the environment.

Middleware as used herein refers to a collection of infrastructure components that enable communication of different system components.

System agents as used herein refers to agents that model and represent the physical components within the real world system of interest so as to keep track of the state of its physical and hence system components, to make that state information available to other agents, and to recognize and inform other agents about existing or predicted non-normal conditions of that system.

Function agent as used herein refers to a repository of intelligence that tracks and compares the real world process to its knowledge base with what the process should be for efficient, effective, and safe execution.

Priority processing as used herein refers to the way in which agents determine the priority of execution within the community of other agents, with respect to precedence of error reporting, cueing, and warning, among others.

Examples in accordance with the present invention relate to methods and apparatus for an intelligent human-machine interface. By way of example, but not limited thereto, examples of methods and apparatus are presented of an intelligent human-machine interface for the physician/patient encounter, and more particularly, to systems and processes for real-time management and feedback of process control, situational awareness, logistics, communication, and documentation, herein referred to as Enterprise Management System (EMS) 172. One element of the EMS 172, among others, provides a knowledge base that organizes information and rules that enables an accurate, relevant, and timely decision support system. The knowledge base is represented in a hierarchical structure of functions and systems. The EMS 172 serves as platform for the avoidance, detection, and timely correction of errors; and as such, acts as a countermeasure to error.

FIG. 11 is a schematic diagram showing EMS 172 as a layered structure 400 comprising an interface shell 420, a system agent 430, and a function agent 440, in accordance with an example of the present invention. The interface shell 420 is a hardware and software interface between the systems, subsystems, and elements of the HCT 100 and the system agent 430 and the function agent 440. The interface shell 420 further comprises hardware and software required to host the system agent 430 and the function agent 440 and to link the function and system agents 430, 440 with the structural elements of the HCT 100.

The interface shell 420 includes several possible work tables and forms, such as a feedback form 461 for eliciting patient feedback on the encounter and intake form 462 used in the beginning of the encounter process. Other patient-centered forms include education results form 465, test results form 466 and a wellness map and dashboard 468, all of which may be made available at the out-brief station, emailed, accessed on the web or printed as hardcopy and delivered in other manners. Work tables for the physician or clinician may include various medical device station worktables 460 appropriately configured for the tests at that station, a diagnostic work table 463, and a community health and epidemiology work table 464.

The function agent 440 may have several sub-agent functions such as medical device station agents 470, network/internet agent 471, insurance agent 472, finance agent 473, pharmacy agent 474, EMR agent 475, community health and epidemiology database agent 476, reference agent 477, an other provider agent 479, and an external database agent 480. The external database agent 480 may allow for connection to one or more external databases such as clinical history database 481, community database 482, and global database 483.

The system agent 430 includes the overall controlling program, the Healthcare Toolkit system agent 450 which provides the coordination and interface between the interface shell 420 and the function agents 440. The system agent 430 may also include one or more sub-agents controlled by Healthcare Toolkit system agent such as patient interview sub-agent 453, patient system agent 481, patient treatment sub-agent 455, patient out-brief sub-agent 456, and past medical history (PMH) agent 452 which operate for the specific patient during the encounter. In some examples of the HCT 100, the patient may be unknown or their medical history is unknown. Accordingly, an emergency response sub-agent 454 can provide the necessary guidance of the creation of the encounter until the identity of the patient is determined. In some examples, the patient agents in the system agent may be implemented as function agents or incorporated as part of the function shell. That is, any particular agent or function can be distributed amongst the various layers of interface shell, system agents and function agents and still meet the scope and spirit of the invention.

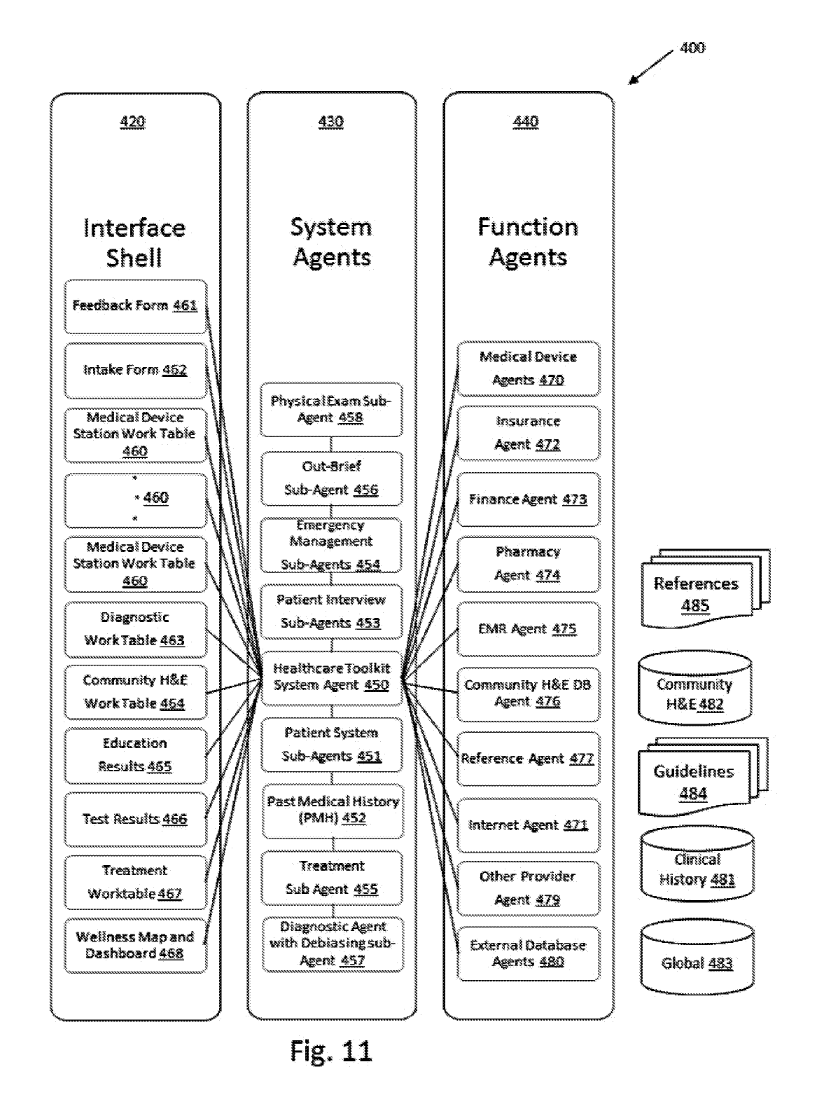

FIG. 12 is a schematic diagram of a work table system 700 in accordance with the present invention. Work tables are provided to the HCT 100 operators. Each work table encounter form 702 has certain steps, methods, and specific checks to insure encounter quality and patient safety. A work table based on current practice distills down the items found to be essential as defined by the texts, professional guidelines, standard operating procedures and the primary items for best practice is provided. EMS 172 monitors in real-time clear thought verification and definitive observed action throughout the process. Each element of the encounter has its own work table items that dovetail into complete encounter form 20 instilled into EMS 172.

Work table information is prioritized according to the urgency or priority of actions. In one example in accordance with the present invention, information is provided by display screens 111 installed in the HCT 100 with which the operator can navigate quickly through the screens to locate information, such as by touch and voice command, among others. Clinicians can find the best practice of a respective procedure, diagnosis, or treatment, be it caused by anticipated or unanticipated events or conditions.

Dynamic documentation increases situational awareness on the part of HCT 100 healthcare team members. The inclusion of specific electronic tablet 110 input identifies the human actors and holds them responsible for the accuracy and effort to accomplish the checklist-prescribed event. The process meshes smoothly with the healthcare team members' activities, as well the overall activity in the HCT 100. Intelligent prompts are conveniently packaged in the form of both pre-described inputs through a work table, and the Work table can, in an example, be transmitted to a flat screen monitor 113 or local manager computer 250 (see FIG. 5) providing situational and logistics information as well, to which the HCT 100 team can view and respond. The end result is increased team member alertness, vigilance, and orientation during the physician/patient encounter.

The state of the patient 704, captured by the patient system agent, can be defined as the aggregate of, but not limited to: clinical history; physical exam findings; current laboratory and radiology findings; and current physiological state of the patient. Clinical history includes identifying data, medical history, allergies, medications, and family history, among other things. The clinical history database follows the standard framework of medical history format currently taught in medical and nursing schools: history of present illness, including current working diagnosis, differential diagnoses and symptoms; past medical history, including actively treated diagnoses, inactive diagnoses, treating or managing physicians for each listed diagnosis; past surgical history; allergies, including allergenic substance, and associated types of reaction; usual medications, dosage and administration instructions, prescribing physician, date began, degree of patient compliance, time and date of last dose, intended medical condition for each medication; and family history, including type of disease, relative with disease, basis of the relative's diagnosis, among other things.

Within this clinical history, prior lab and radiology information pertinent to the diagnosis is captured. The clinical history is summarized in the form of diagnosis: the working diagnosis and differential diagnosis, as well as co-morbid disease processes, among other things.

The history of the present illness documents the data supporting the encounter working diagnosis. The supporting symptoms and signs, as well as pathologic diagnoses can be captured by, among other ways, with ICDS 9 or ICDS-10 codes maintained by the World Health Organization, the directing and coordinating authority for health within the United Nations System. The codes are designed as a health care classification system, providing a system of diagnostic codes for classifying diseases, including nuanced classifications of a wide variety of signs, symptoms, abnormal findings, complaints, social circumstances, and external causes of injury or disease. This system is designed to map health conditions to corresponding generic categories together with specific variations, assigning for these a designated code, up to six characters long. Thus, major categories are designed to include a set of similar diseases. Another classification system is SNOMED CT. SNOMED CT or SNOMED Clinical Terms is a systematically organized computer processable collection of medical terms providing codes, terms, synonyms, and definitions used in clinical documentation and reporting. SNOMED CT is considered by many to be the most comprehensive, multilingual clinical healthcare terminology in the world. The Unified Medical Language System (UMLS) is a compendium of many controlled vocabularies in the biomedical sciences which may also be used. It provides a mapping structure among these vocabularies and thus allows one to translate among the various terminology systems; it may also be viewed as a comprehensive thesaurus and ontology of biomedical concepts. RxNorm is another standard for medications. It is part of UMLS terminology and is maintained by National Library of Medicine. Central medication databases such as Surescripts may also be used. Surescripts facilitates timely, secure access to vital clinical information in all 50 states. The Surescripts network enables standards-based connectivity and a broad range of health information exchange.

Under each diagnosis found in clinical history, a hierarchical series of ICDS 9/10 codes are arranged from the broadest and most inclusive diagnosis followed by the ICDS 9/10 codes for the supporting symptoms. The ICDS 9/10 conventions specify pathology and location as well as grading as to the severity. For example, most disease processes are set up in 1, 2, 3 manner (mild, moderate or severe). Additional special disease processes are defined by lab values, such as heart disease, 30 percent occlusion of vessels, versus 60 percent, versus 90 percent. The ICDS 9/10 codes typically accommodate all of this data, with expanded and high resolution (specific) coding of the patient's condition being the insurance and hospital industry standard. The lesser codes catalogue symptoms, physical exam findings, and impressions such as: “right lower quadrant pain”, “angina pain”, “tenderness”, “immobility of knee”. The second tier of codes would also annotate location and severity. The catalog of symptoms and clinical signs find ready application during the encounter, as the physician assesses the physical findings upon testing at the medical device stations 221 and tries to correlate the intra-encounter pathological findings to the patient's actual complaints.

Past medical history (PMH) includes the diagnoses, both active and inactive, that are established in the patient's medical history. PMH diagnosis are set up in a hierarchical priority as to impact on life, and graded as to how assured the diagnosis was established.

The past medical history module documents methods confirming the diagnosis: whether based on clinical signs and symptoms alone, versus radiographic proof, versus surgical and biopsy proof. The PMH may include diagnoses made by various physicians. Oftentimes, the encounter physician or medical provider need access to the diagnosing physicians; therefore, each diagnosis needs to include a data link (telephone number, email) to the physician who made the diagnosis, and the physician or entity that is currently managing that problem. If the problem diagnosis rises to significance, the managing physician could be readily consulted to aid in evaluation and management.

A full catalogue of the patient's drug and environmental allergies is included, comprising the allergen substance and the resultant adverse reaction. The adverse reaction would be specific: anaphylactoid reactions versus hives, versus dyspnea, versus psychological dread. Additional piece of information with each substance or allergen would be the certainty that the reported allergy is true.

The catalogue of the patient's usual medications includes pharmacologic substances (prescription, OTC, and herbal/folk medicines) that are taken on a regular basis. The list includes the name of the medication, dosage, administration directions, and prescribing physician. Data would include when the medication was started, the degree of patient compliance, and the time and date of the last dose.

The past medical history module includes the family disease history, and specifies the disease and afflicted individuals in the family tree, as well as the method of confirmation (hearsay versus autopsy, laparoscopy, surgical or conjecture). Additionally, family history could include information, such as, but not limited to, on anesthesia reactions and malignant hyperthermia.

Laboratory findings references pre-encounter data not including the stream of current lab values generated by the MMDs 150 within the encounter. These baselines include the various tests (CSC, Dig Level, chem. screen, etc.), with times, dates, and if applicable, a trend graph of the multiple data points for lab drawn on a repetitive basis. Catalogues provide precise alphanumeric tags of laboratory tests and values.

Radiology studies include the type of study, date, facility, and radiologist. It will have a summary of the findings typically found in radiographic reports. If the radiograph image is a portion of an electronic data pool, the retrieval address and code would be included to summon the image for HCT 100 viewing. This includes EKG, echocardiography, and pulmonary function test results reported in the standardized language of the American College of Cardiology and Pulmonary Medicine.

Notable physical findings that the physician and healthcare providers want referenced would be compiled into a database log according to the routine history and physical (H&P) format. These significant findings include: measurements, locations, and data that should be correlated with the patient's complaints in the history of present illness (HPI), and the intra-encounter findings at the time of diagnosis and treatment.

Cardiovascular Vitals (CV) Signs 506 includes pulse rate, blood pressure, oximetry data, and cardiac tracing. EKG type descriptors such as regularity versus irregular rhythm and segment changes would be recorded. Many existing software packages employ automatic cardiac tracing analysis programs that are able to recognize rhythm and segment changes. Access to prior EKG tracings via the past medical history (PMH) allows comparisons to be made intra-encounters. The entirety of the CV signs data is captured electronically from the patient medical monitoring stations.

Pulmonary Data includes tidal volume, inhalation and exhalation volumes and pressures, O2 saturation, and CO2 saturation.

The Internet is a very useful modality in terms of accessing information and expert help. Internet can be used for sending patient images, verbal transmission, as well as eye-to-eye contact with expert help. The expert could receive the surgical images, obtain the medication log, vital signs, among other things. Access to a broad array of data and images enables the expert tele-consultant to readily understand the situation and give sound advice via the Internet. Of course, various government regulations such as HIPAA require Direct Messaging standard or other secure methods and protocols which may be used with HCT 100 whenever patient-specific clinical information is being transferred.

There is advice and information within the clinical setting that many times is not readily available. Prior radiographic studies, lab tests, or discussions with the radiologist or pathologist may be needed intra-encounter. Using EMS 172 in communication with the clinical network, one can access these images and access direct discussion with the experts. Similar activities can be done with logistical support and actually talking with the supply clerk and having them display an item to the circulator prior to delivering it.

Within the clinical network connection there is also medical records that may be more extensive and have free stream data not available on the patient's state module or the patient agent software. This could be accessed if need be or dispatched if in paper format.

Clinical network connections are also helpful for querying in-house physicians that are logged in. For example, a physician in the HCT 100 can communicate with an urologist if needed for a particular opinion or for surgical assistance. The system can query the clinical database and if there is an individual with the qualifications available, that person can be paged and immediately brought to the HCT 100 to render assistance or advice. This prevents searching for a particular doctor. Also this method is used to make telephonic connection or audiovisual connection with specialty people that are on the clinical network that may or may not be in-house.

### Local Population Database:

One significant feature of the Health Care Toolkit is that the LMS 250 can be configured to create a local community health and epidemiology database 482 and the EMS 172 may create a community health and epidemiology work table 464 (made up of work tables 166 and encounter forms 174) based on the outcomes of the set of patients in the local community database 482 to identify local trends, common illnesses which may need to be addressed, creation of virtual or “bricks and mortar” support groups or perhaps indications of widespread bacterial or other contagious diseases, environmental contamination, radiation poisoning, and the like. Further, the local community H & E database 482 can be used to help in the diagnosis of a patient's illness by having the EMS 172 able to create individual diagnosis, treatment, and feedback encounter forms 174 and work tables 166 for the physician to reflect the probability of hypothesis taking into account the local community health and epidemiology database 482 group results and probabilities. EMS 172 may also be interoperable with other systems (including public health) for both patient-specific and community health data.

### Superior Diagnosis:

When reviewing the results of the various tests, the diagnostic encounter forms provide assistance to the physician to make an appropriate diagnosis and helps avoid absolute judgment limits. The HCT 100 utilizes the physician's ‘mental model’ and thus is more intuitive and anticipatory in its use than conventional approaches. The graphic interfaces, such as the diagnostic work table 463 and the treatment work table 467 create a graphic and textual space for the provider (and the patient) to actually think about and manipulate data and physical findings into diagnosis and treatment.

When an error or misuse is detected, the physician is provided a recovery solution. To help in the diagnosis the encounter forms can provide access to electronic medical references such as MedLine (run by NLM an accessed using PubMed or Ovid) as well as electronic decision support tools. The encounter form allows the physician to connect to the EMR 264 (FIG. 5) to retrieve, present in chronological order, and update the patient medical information and history upon the physician's confirmation. The physician or clinician may take notes and save them at all stages of the diagnostic process including his/her findings of the physical examination. Also, the physician may be allowed to list the potential hypothesis and add or reduce the hypothesis list as well as prioritize them. The list of suggested diagnostics is presented after the physician has reviewed the patient's data. The encounter form presents all symptoms associated with each diagnosis in the hypothesis list to reduce workload on the physician working memory. The physician may order additional medical tests and if necessary, continue to update the patient's medical history. The encounter form allows for the recording of the physician's final understanding of diagnosis, feedback, and recommendations. When needed, the physician may share the patient's problem with remote specialists. Once the physician makes a final diagnosis, the encounter form provides the physician with feedback of the final diagnosis.

The diagnostic encounter form is consistently designed with the ‘physician mental model’ using a standard format in the design of different pages of the user interface to increase usability and productivity while reducing errors. Other usability factors include using color coding corresponding to established conventions for redundancy gain while not impacting those operators who may have color deficit issues. The color coding may use 5 to 7 hues in a single screen to avoid absolute judgment limits. Additionally, color and shape are utilized to facilitate the perception of information. The encounter forms optimize the legibility of visual signals considering the effect of ambient illumination. Accepted symbols icons, colors, and abbreviations help to convey information reliably and quickly. Accordingly, unambiguous labels for the buttons can be easily read due to symbol size, contrast, and color.

To further reduce the information cost to the physician or other operator, the encounter form aids them to keep track he diagnostic process by showing the current step of the process within the user interface. The encounter form is also designed to provide the ability to of moving among different pages easily. Moreover, the encounter form integrates related information to further reduce the information access cost.

Auditory signals are also utilized to implement alarms that meet or exceed the normal hearing and visual limits of the user. The auditory signals intensify sufficiently according to the amount of ambient illumination. When an alarm is very serious, the encounter form utilizes alternative physical forms for an alarm.

### Debiasing Tools

The HCT 100 allows for differential diagnosis, which is a process of identifying all of the possible diagnoses that could be connected to the signs, symptoms, and lab findings, and then ruling out diagnoses until a final determination can be made. To reduce the likelihood of Premature Closure, Representativeness, Anchoring, Availability, and Overconfidence in the diagnosis, the diagnostic encounter form may include cognitive debiasing tools. A cognitive bias is a pattern of deviation in judgment, whereby inferences about other people and situations may be drawn in an unfounded or inconsistent fashion. Physicians may create their own subjective diagnosis from their perception of the information presented by the HCT 100 A physician's subjective construction of the diagnosis, not the objective input, may dictate their decisions for treatment that may not be what is in the best interest of the patient. By having a set of debiasing tools and a process, such cognitive bias by a physician can be reduced where the objective analysis is inconsistent with the physician's subjective diagnosis. Where the physician determines that his/her subjective diagnosis is correct given all the available information, his diagnosis can be available from the local community database for other physicians to view and observe and take into account in their own diagnosis of other patient illnesses.

Where possible, the design of the debiasing memory tools should be consistent with the iOS standards described earlier in the Human Interface Guidelines and also consistent with the rest of the encounter form standards. To help guide the physician, subtle but clear visible and audio feedback is used. Appropriate metaphors and images are used to convey the functionality as well as quickly displaying appropriate labels when it is desirable to convey the functionality of the debiasing memory tool. The debiasing memory tools only act as a mnemonic and does not interfere with the diagnostic decision making and is designed to not increase the physician's cognitive burden. However, the EMS 172 creates diagnostic work tables 463 with debiasing memory to prevent a physician from weighing an initial hypothesis more favorably over other hypothesis suggested by the EMS 172 diagnostic encounter form. In addition, the local manager station 150 can be configured to create a local community health and epidemiology database 482 (FIG. 11) in appropriate situations (disaster response, community health clinics, environmental illnesses, etc.) based on the outcomes of each of a set of a local group of patients. The EMS 172 may then be configured to consider the true base rate of illnesses with respect to both the local community health and epidemiology work table and global databases 483 and use the local community health and epidemiology database 482 to further pinpoint the diagnosis to detect common illnesses or afflictions. If there is a sufficient predetermined number of local patients who have similar diagnosis the EMS 172 may be configured to create support groups for the respective patients and provide information in the out-brief station or later correspondence on how the patient may access any appropriate support groups. Similarly to help the physician or other clinicians performing the local community clinic or disaster response the EMS 172 may modify the appropriate encounter forms to provide audio, visual, and written information for the local community health and epidemiology database 482 including at least one of table wave files (see EKG results 133 in FIG. 8A) with expanded fast Fourier transforms and photo-cardiology to allow for tele-medicine to get additional specialist input.

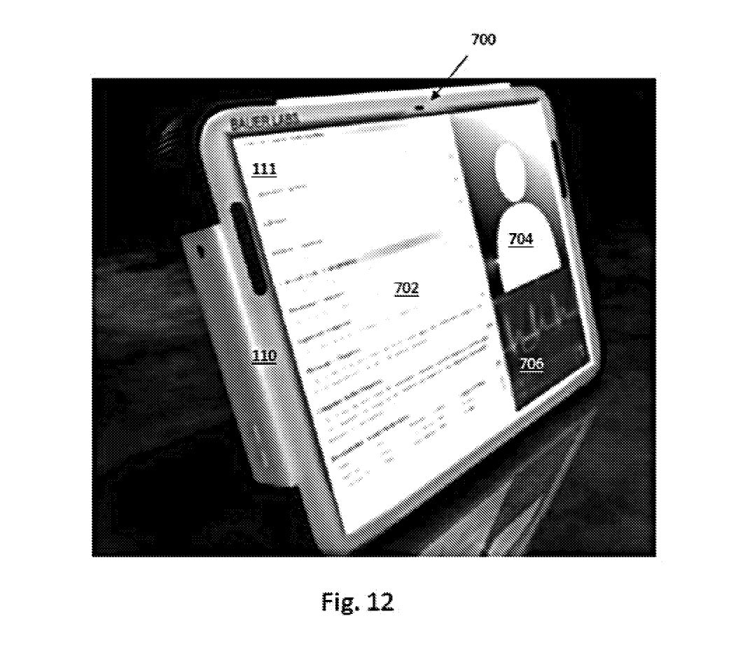

FIG. 13 is a flowchart of one example of the diagnostic debiasing memory tools 500 and process. The debiasing memory tools 500 should be specifically attributed to different stages of diagnosis. There are several debiasing memory tools 500 available in the HCT 100 and include anchoring debiasing tool 520, availability debiasing tool 530, representative debiasing tool 540, and confirmation debiasing tool 550. All debiasing memory tools 500 should as in first block 502 provide a brief checklist for checking essential information at each stage, including medical history and lab test results at the data gathering level.

The anchoring debiasing tool 520 is to prevent the physician from forming an early decision before all data is reviewed. Accordingly, in second block 504, the physician is encourage by the HCT 100 to review all the patient's information before making a decision. Further, as in third block 506, the HCT 100 discourages the physician to weigh the information that supports his/her initial hypothesis more heavily than other information available. In one example, the anchoring debiasing tool 520 has the physician also review information from the local population database to ensure that symptoms, diagnoses, and treatments from other similarly co-located patients are taken into account in case there are contagious, communicable, environmental, or group psychological illnesses which should be considered.

The availability debiasing memory tool 530 is used to help the physician understanding what the likelihood of his/her diagnosis is with respect to the global population, recent diagnoses the physician has made and in some examples, diagnosis for a local community made by one or more other physicians. In fourth block 508 the HCT 100 encourages the physician to consider the true base of illnesses from one or more databases or online references, including recent case studies. In fifth block 510, the HCT 100 may encourage the physician to consider the history of recent diagnoses even if the true base rate is low in order to determine if there is a trend or if other factors need be considered, particularly for treatment and possible group therapy.

The representation debiasing memory tool 540 is used to help prevent the physician from forming a bias because of a tendency to “judge the frequency or likelihood” of an occurrence by the extent of which the event “resembles the typical case.” In sixth block 512, the representative availability tool 540 in the HCT 100 represents the actual occurrence probability of a hypothesis to mitigate such representativeness bias. Further, in seventh block 514, the representation debiasing tool 540 encourages the physician to search for inconsistencies between the patient's symptoms and the potential diagnosis.

The confirmation debiasing memory tool 550 is used to reduce the tendency of a physician to search for or interpret information in a way that confirms his/her preconceptions. In addition, physicians may discredit information that does not support their diagnosis. Accordingly, in eight block 516 the HCT 100 encourages the physician to look for more data that proves disconfirming evidence from an objective analysis of the data. Also, in the ninth block 518 the HCT 100 discourages the physician from misinterpreting ambiguous cues to support their hypothesis.

### Treatment Plan

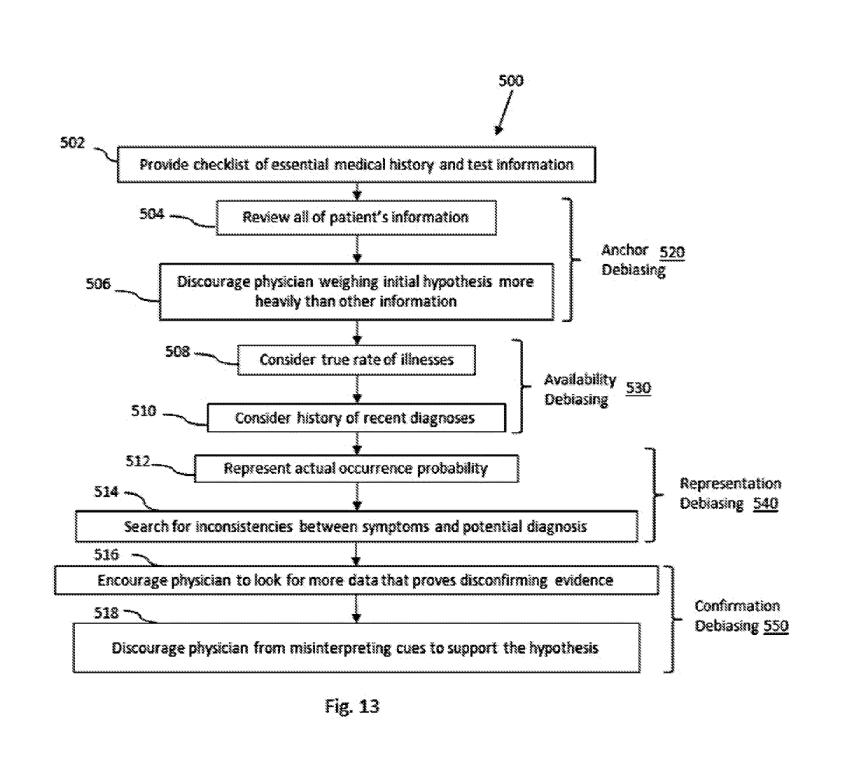

FIGS. 14 through 18 are example treatment work table 600 encounter forms 174. The HCT 100 helps the physician create a treatment plan using the example treatment work table 600 encounter forms 174 based on the patient's symptoms and the physician's diagnosis. The treatment work table 600 may be presented to the patient in the out-brief station 223 (FIG. 5). The treatment work table 600 follows the same user interface design similar to the other work table 166 encounter forms 174. For instance, any buttons located on the encounter form 174 are “big enough” for easy touch control. The encounter form user interface 602 is “uncluttered” and limits the information per page to 10 items. The user interface 602 uses a font that is “easy to read” and uses neutral colors to the maximum extent possible. The encounter form 174 may use a bi-directional flow so the operator can go forwards and backwards through the user interface 602. The encounter form 174 allows for auto-save continuously while allowing the physician or other provider to undo changes. To make more personable, the encounter form 174 allows the physician to customize certain usability aspects of the form. For instance, the user interface 602 can be adaptable to both left-handed and right handed operators. The HCT 100 may provide input feedback, such as haptic feedback, audio feedback, etc. when a selection is made. For security, the HCT 100 prevents unauthorized access to the encounter form 174.

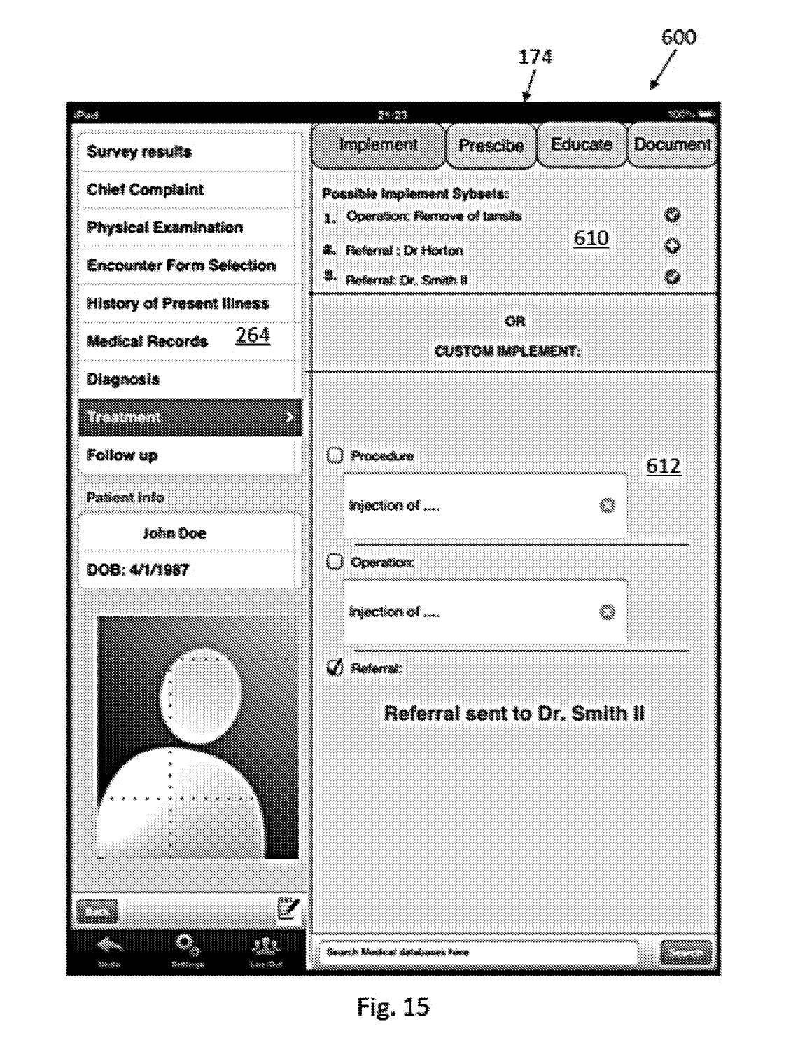

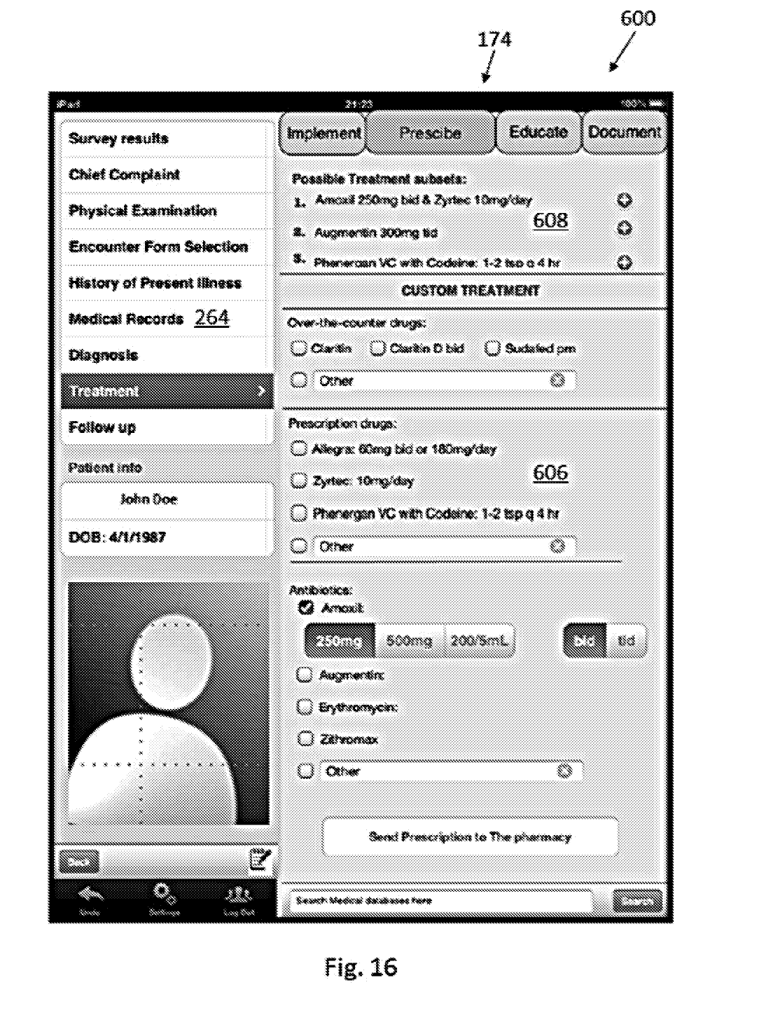

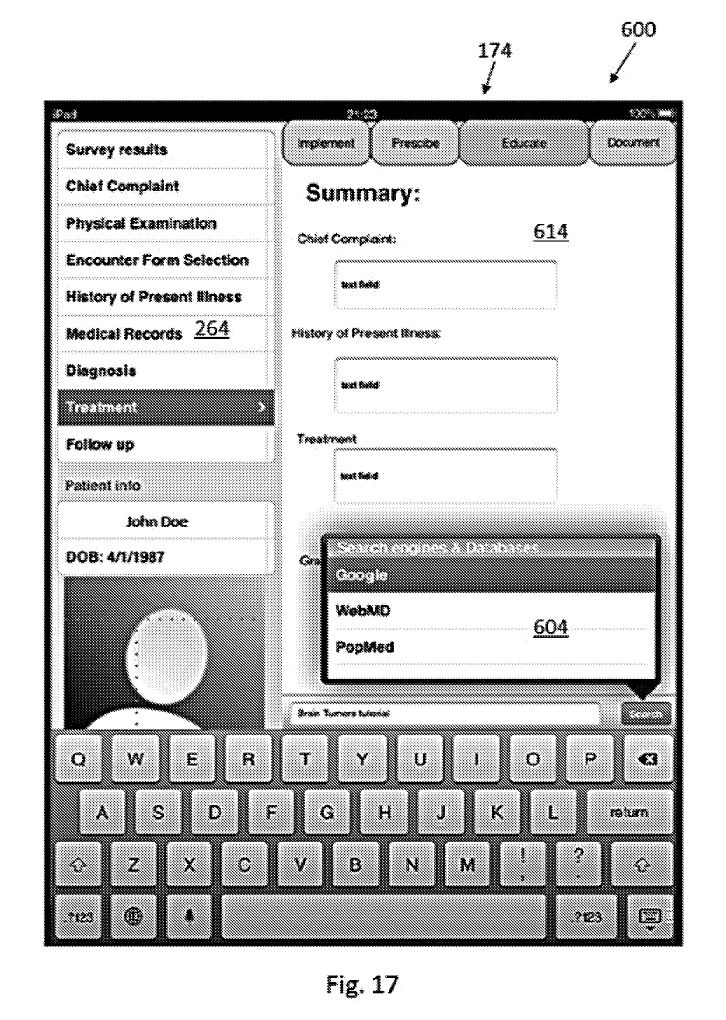

Additional functionality of the treatment work table 600 encounter form 174 is the ability to allow the physician to access online references 604 as shown in FIG. 17, particularly for treatment options. Further, the encounter form 174 may access the patient's electronic medical records (EMR) 264 (FIG. 5) as shown in FIG. 18. This allows the encounter form 174 to provide a summary of all current medical medications 606 in FIG. 16, either from the patient's EMR 264 or the initial interview checklist. The encounter form 174 also allows accessibility 616 as shown in FIG. 18 to the patient's existing conditions as well as the patient's past treatments, such as through pop-up window 620. The encounter form 174 can also alert the physician of any possible interactions 608 between entered medications. The encounter form 174 may also recall previously prescribed medications and display it for the provider. The last frequencies and dosages may be displayed for any recurring medication from previous encounters. The physician may input alternative dosages and frequencies for medications other than those suggested by the treatment work table 600. The physician may send any proscribed prescriptions to a local pharmacy and be able to export a printed prescription to external pharmacies not network connected to the HCT 100. The encounter form 174 is able to indicate if the pharmacy has received the prescription.

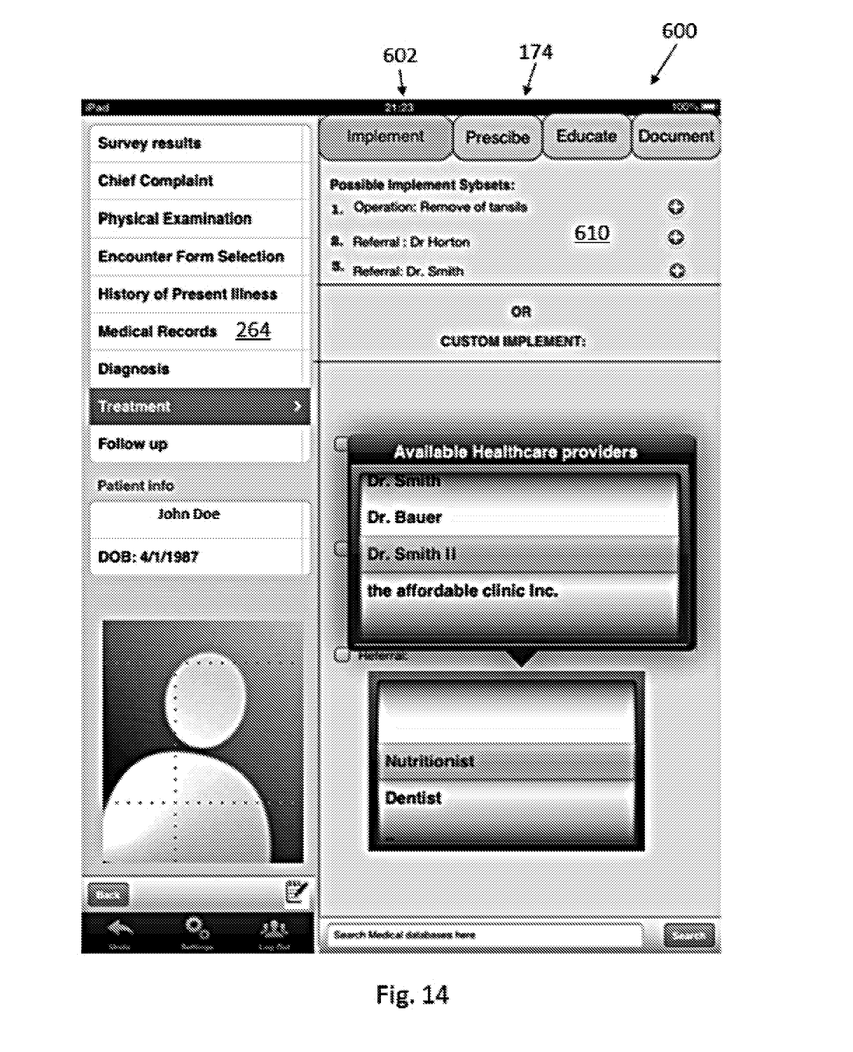

The treatment work table 600 may prioritize and display a relevant subset of possible treatment options 610 as shown in FIG. 14 and FIG. 15 depending on the information obtained during the patient interview and diagnosis. Also the encounter form 174 may allow for indicating that the patient refused treatment. In some situations, a physician may want to provide alternative treatments 612 shown in FIG. 15 other than those suggested by the HCT 100, such as a referral to a specialist. If so, these may be inputted into the encounter form 174. The treatment work table 600 may provide the physician needful information for a treatment implementation.

Finally, the treatment work table 600 allows the physician to educate the patient about their diagnosis and treatment as shown in FIG. 17. Accordingly, the physician may have access to educational online references 604 through the encounter form 174 for the patient and can present the information to the patient using a form with the physician's standardized template. The treatment work table 600 allow the physician to update the encounter from 174 with all treatment decisions. A summary 614 of the treatment for the physician's approval is presented before completing the documentation of the treatment.

RFID ID device 112 Example

FIG. 19A is a top view of a RFID sensor sheet 570, in accordance with an example of the present invention. The RFID sensor sheet 570 comprises an antenna array 572 coupled to a film 571, and electronics 573. The electronics 573 provides power and a communication means for coupling to RFID detection electronics and wired and/or wireless communication electronics to communicate sensor data to an access point connected to a HCT 100 that supports the system's RFID middleware. The wireless communication transceiver provides a no-touch conduit to adjust the RFID's performance settings. The unit may include a self-contained rechargeable battery power source.

FIG. 19B is a side view of the RFID sensor sheet 570, in accordance with an example of the present invention. The antenna array 572 is adapted to create a specific volume of space 575 that an RFID tagged patient will be reliably detected. The film 571 serves as a platform to mount the antenna array 572 to any suitable surface 574, such as, but not limited to, an wrist band, an arm band, an ankle bracelet, a patient wrist, an ankle, or other body part.

The RFID sensor sheet 570 provides for rapidly identifying RFID tagged patients and tracking RFID tagged patients within the encounter environment. The RFID sensor sheet 570 readily turns a chosen patient into a waypoint sensing station to monitor both a set of patients and their process flow through the encounter, while also being to keep actual patient identity anonymous in some situations. For instance, the expense and use of RFID can be kept reasonable by having the RFID sensor within a token the patient carries around like a pager that would be useless outside of the screening event and would be re-useable. These tokens could be considered sensor shell waypoints. Sensor shell waypoints are logically chosen from key locations derived from the process model and in turn, the information captured from these waypoints of the sensor shell provide a source of metrics to manage the overall process of the encounter.

FIG. 20 is a photograph of a patient ID device bracelet 580 with a barcode portion 582 and a text based portion 584, both of which may be used to identify the patient. The barcode portion may be read via the HD camera device 126 or an image sensor device on tablet 110. The barcode portion 582 shown is a 1-D barcode but a 2D, 3D, or holographic or other barcode can be used and many are known to those skilled in the art. The patient ID bracelet 580 may be printed and placed on the patient at the intake station after the identity of the patient has been verified, such as by photo-id or other. The patient ID bracelet 580 may also readily turn a chosen patient into a waypoint sensing station to monitor both a set of patients and their process flow through the encounter. Sensor shell waypoints are logically chosen from key locations derived from the process model and in turn, the information captured from these waypoints of the sensor shell provide a source of metrics to manage the overall process of the encounter.

In summary, a method for providing an intelligent human-machine interface in accordance with an example of the present invention HCT 100 includes providing an interface shell 420, providing a system agent 430 including one or more dynamic, knowledge-based software object sub-agents such as patient system sub-agent 451 adapted to model and track the state of a patient encounter form 174, and providing a function agent 440 adapted to model, track, and facilitate work table 166 and other form interface functions. The interface shell 420 is adapted to provide a hardware and software interface between the system agent 430 and the function agent 440. The method further includes creating a system hierarchy model of the structural elements of a system (FIG. 4) and a functional model (FIGS. 10-11) of the patient encounter, retrieving medical data from medical diagnostic devices, and communication systems necessary to implement functionality, identifying component and interface specifications for the acquisition and integration of the physical components, creating functional model software specifications, and utilizing a model based knowledge base to construct the hierarchy and operations.

In addition, an intelligent human-machine interface for a patient-centered healthcare toolkit includes an interface shell 420 including a patient identification (ID) device reader to uniquely identify individual patients with a patient ID 122, a set of function agents 440 that interface to one or more electronic medical records 264 using the patient ID 122, one or more knowledge bases (485, 484) and one or more clinic databases (481, 483). Also included is a set of system agents 430 including one or more dynamic medical measurement device agents 470 to wirelessly gather at least one of physiologic, radiographic and bio-chemical data, the system agents 430 to wirelessly communicate with the interface shell 420 to one or more electronic tablets 110 to create work tables of patient-centered encounter forms based on the patient ID for each medical measurement device 150 using the interface shell 420 and the set of function agents 440. The system agents 430 further include at least an interview agent, a diagnostic agent, a treatment agent and an out-brief agent, wherein the diagnostic agent 457 and the treatment agent 455 use a physician mental model of diagnostic and treatment work tables that are intuitive and anticipatory in use with graphic interfaces to create a graphic and text space to think about and manipulate data and physical findings.

A method for providing an intelligent human-machine interface includes the steps of providing an interface shell 420, a system agent 430 including one or more dynamic, knowledge-based software object sub-agents including a patient system sub-agent 451 adapted to model and track the state of a patient encounter form, and a healthcare toolkit system agent adapted to model, track, and facilitate medical measurement work table and other form interface functions. The interface shell 420 is adapted to provide a hardware and software interface between the system agent 430, the function agent 440, and a set of medical measurement devices 150 to wirelessly gather at least one of physiologic, radiographic, and bio-chemical data. A system hierarchy model of the structural elements of a system and a functional model of the patient encounter based on a physician mental model of patient centered medical encounter flow (FIG. 4B) is provided and includes a) wirelessly retrieving medical data from the set of medical measurement devices 150, and communication systems via a set of function agents necessary to implement functionality, b) identifying component and interface specifications for the acquisition and integration of the medical measurement devices 150, c) creating functional model software specifications, and d) utilizing a model based knowledge base to construct the hierarchy and operations.

A management system 172 for a healthcare toolkit using a physician “mental model” of exam flow (FIG. 4B) includes an interview agent 453 that communicates to a client intake station 215 which includes a set of identification (ID) devices 122 to uniquely identify each of a set of patients. The interview agent 453 wirelessly communicates with a wireless electronic tablet 110 to read the set of ID devices 122. The electronic tablet 110 includes a set of patient-centered encounter forms including a patient intake encounter form to collect patient self-knowledge of their problem and the electronic tablet 110 allows for the requisition of any test requisitions. A set of medical measurement agents 470 communicates with a respective set of medical measurement devices (MMD) 150 to gather at least one of physiologic, radiographic, and bio-chemical data for the test requisitions, each MMD 150 has wireless connectivity to operate with a respective wireless electronic tablet 110 via respective patient-centered MMD work tables and encounter forms based on the ID devices along with clear and consistent guidelines to follow. A diagnostic agent 457 and a treatment agent 455 use a physician mental model of diagnostic and treatment work tables that are intuitive and anticipatory in use with graphic interfaces that create a graphic and text space to think about and manipulate data and physical findings. An out-brief agent 456 communicates with an out-brief station where at least one of copies of the test results, prescriptions, therapy choices, education information, follow-up appointments, referrals, and billing are presented to an appropriate patient with the respective ID device 122.

Further, a patient-centered Healthcare Toolkit 100 includes a set of identification (ID) devices to uniquely identify each of a set of patients and an electronic tablet having wireless connectivity configured to read the set of ID devices. The electronic tablet includes a set of patient-centered encounter forms including a patient intake encounter form to collect patient self-knowledge of their problems. A set of medical measurement devices are each configured with wireless connectivity to operate with the electronic tablet via respective patient-centered encounter forms created from an enterprise management system (EMS) using a physician “mental model” of exam flow used to gather at least one of physiologic, radiographic and bio-chemical data, any test requisitions for each of the medical measurement devices, and to provide correct and consistent guidelines to an operator of the electronic tablet.

While the present invention has been particularly shown and described with reference to the foregoing preferred and alternative examples, those skilled in the art understand that many variations may be made therein without departing from the spirit and scope of the invention as defined in the following claims. This description of the invention should be understood to include all novel and non-obvious combinations of elements described herein, and claims may be presented in this or a later application to any novel and non-obvious combination of these elements. The foregoing examples are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

### BIBLIOGRAPHY

1) Apple Inc. —iOS Developer Library (2011). iOS Human Interface Guidelines [Data file]. Retrieved from http://developer.apple.com/library/5 ios/navigation/
2) Sawyer, D. (1996). Do It By Design—An Introduction to Human Factors in Medical Devices. Office of Health and Industry Programs FDA. Retrieved from http://www.fda.gov/MedicalDevices/DeviceRegulationandGuidance/PostmarketRequirements/QualitySystemsRegulations/default.htm
3) United States Food and Drug Administration. (2011). Draft Guidance for Industry and Food and Drug Administration Staff—Mobile Medical Applications [Data file]. Retrieved from http://www.fda.gov/MedicalDevices/DeviceRegulationandGuidance/GuidanceDocuments/ucm263280.htm.
4) Zingale, C., Ahlstrom, V. & Kudrick, B. (2005). DOT/FAA/CT-05/15 Human Factors Guidance for the Use of Handheld, Portable, and Wearable Computing Devices. Federal Aviation Administration. Retrieved from http://hf.tc.faa.gov/products/bibliographic/ct0515.htm.
5) NIST Health Information Technology Usability Framework. Retrieved from http://www.nist.gov/healthcare/usability/framework.cfm and Human Factor Guidelines retrieved from http://www.nist.gov/healthcare/usability/humanfactorguidelines.cfm.
US Code of Federal Regulations, Title45, Volume 1 (Revised Oct. 1, 2005): of Individually Identifiable Health Information (45CFR164.501). Retrieved from http://frwebgate.access.gpo.gov/cgi-bin/get-cfr.cgi?YEAR=current&TITLE=45 &PART=164&SECTION=501&SUBPART=& TYPE=TEXTPrivacy.
“Health information Privacy”. U.S. Department of Health & Human Services. Retrieved from http://www.hhs.gov/ocr/privacy/hipaa/understanding/consumers/index.htm128.
Meaningful Use (MU) standards. American Recovery and Reinvestment Act of 2009, Subtitle A—Promotion of Health Information Technology, PART 1—IMPROVING HEALTH CARE QUALITY, SAFETY, AND EFFICIENCY, SEC. 13101. ONCHIT; STANDARDS DEVELOPMENT AND ADOPTION. Retrieved from http://thomas.loc.gov/cgi-bin/query/F?c111:8:./temp/˜c111U3Q82f:e356454:

### APPENDIX 1

### Human Factors Guidelines

1. ANSI/AAMI HE75, 2009 Edition—Human factors engineering—Design of medical devices.

2. DOT/FAA/CT-05/15—Human Factors Guidance for the Use of Handheld, Portable, and Wearable Computing Devices:
Devices must have an easy means of connecting to and transferring data to or from other systems.
Devices should have good legibility and color contrast, and be easy to learn.
Devices should be sufficiently durable to withstand drops and knocks associated with normal use.
Devices must have sufficient battery life for task completion.
If the device is used to transmit data over a wireless network, it should have consistent and available connectivity.
If a stylus is used, it should be attached to the device.

3. iOS Human Interface Guidelines (for iPhone, iPad, iPod)

Apple focuses its User Interface around these principles:
Aesthetic Integrity: a measure of how well the appearance of the app integrates with its function.
Consistency: A consistent application is an application that takes advantage of the standards and paradigms people are comfortable with.
Direct Manipulation: When people directly manipulate onscreen objects instead of using separate controls to manipulate them, they're more engaged with the task and they more readily understand the results of their actions.
Feedback: People expect immediate feedback when they operate a control, and they appreciate status updates during lengthy operations.
User Control: People, not applications, should initiate and control actions. Although an application can suggest a course of action or warn about dangerous consequences, it's usually a mistake for the app to take decision-making away from the user.
Determination of Customers: In the context of the app you′re planning, what is most important to your users?

4. FDA's Draft Guidance for Industry and Food and Drug Administration Staff—Mobile Medical Applications

The guidelines that the inventor determine to be applicable to the Healthcare Toolkit can be found in the Quality Systems Regulation: 21 CFR 820 Subpart C—Design Controls Sec. 820.30 Design controls.

(b) Design and development planning Each manufacturer shall establish and maintain plans that describe or reference the design and development activities and define responsibility for implementation. The plans shall identify and describe the interfaces with different groups or activities that provide, or result in, input to the design and development process. The plans shall be reviewed, updated, and approved as design and development evolves.

(c) Design input. Each manufacturer shall establish and maintain procedures to ensure that the design requirements relating to a device are appropriate and address the intended use of the device, including the needs of the user and patient. The procedures shall include a mechanism for addressing incomplete, ambiguous, or conflicting requirements. The design input requirements shall be documented and shall be reviewed and approved by a designated individual(s). The approval, including the date and signature of the individual(s) approving the requirements, shall be documented.

(d) Design output. Each manufacturer shall establish and maintain procedures for defining and documenting design output in terms that allow an adequate evaluation of conformance to design input requirements. Design output procedures 5 shall contain or make reference to acceptance criteria and shall ensure that those design outputs that are essential for the proper functioning of the device are identified. Design output shall be documented, reviewed, and approved before release. The approval, including the date and signature of the individual(s) approving the output, shall be documented.

Also, the Quality Systems Regulation makes reference to the article “Do It by Design—An Introduction to Human Factors in Medical Devices” which contains guidelines that are encouraged to be followed when designing a medical device. The guidelines that fit the Healthcare Toolkit are the following:
Make all facets of design as consistent with user expectations as possible. Both the user's prior experience with medical devices and well-established conventions are important considerations.
Design workstations, controls, and displays around the basic capabilities of the user, such as strength, dexterity, memory, reach, vision, and hearing.
Design well-organized and uncluttered control and display arrangements. Ensure that the association between controls and displays is obvious. This facilitates proper identification and reduces the user's memory load.
Ensure that the intensity and pitch of auditory signals allow them to be heard easily by device users. Consider the effects of ambient noise.
Ensure that the brightness of visual signals is sufficient to be perceived by users working under various conditions of ambient illumination. Also, brightness contrast and color contrast can help to optimize legibility.
Make labels and displays so that they can be easily read from typical viewing angles and distances. Symbol size, contrast, color, and display depth are important considerations.
Ensure that the abbreviations, symbols, text, and acronyms placed on, or displayed by, the device are also used consistently in the instructional manual. They also should correspond to standard nomenclature, if possible.
Design control knobs and switches so that they correspond to the conventions of the user population (as determined by user studies and existing medical device standards).
Arrange and design knobs, switches, and keys in a way that reduces the likelihood of inadvertent activation.
Use color and shape coding, where appropriate, to facilitate the rapid identification of controls and displays. Colors and codes should not conflict with universal industry conventions.
Space keys, switches, and control knobs sufficiently apart for easy manipulation. This will also reduce the likelihood of inadvertent activation.
Make sure that controls provide tactile feedback.
Do not contradict the user's expectation. Rather, exploit their prior experience with computerized equipment and consider conventions related to language and symbols.
Be consistent and unambiguous in the use and design of headings, abbreviations, symbols, and formats.
Always keep users informed about current device status.
Provide immediate and clear feedback following user entries.
Design procedures that entail easy-to-remember steps.
Use prompts, menus, etc. to cue the user regarding important steps; do not “strand” the user.
Give users recourse in the case of an error. Provide conspicuous mechanisms for correction and troubleshooting guides.
Do not overload or confuse users with information that is unformatted, densely packed, or presented too briefly.
Consider the use of accepted symbols, icons, colors, and abbreviations to convey information reliably, economically, and quickly.
Do not over use software when a simple hardware solution is available, e.g., a stand-alone push button for a high priority, time-driven function.

### APPENDIX 2

### System Features

| Reqt # | Requirement | Category |
|---|---|---|
| | Interview | |
| 1 | Interview subsystem shall provide a means to | Functionality |
| | collect and integrate patient medical information | |
| | into medical records | |
| 2 | Interview subsystem shall have a means | Functionality |
| | to connect with the information | |
| | systems to upload and download patient | |
| | medical record information | |
| 3 | Interview subsystem shall integrate new patient | Functionality |
| | information into medical record | |
| 4 | Interview subsystem shall integrate | Functionality |
| | provider's updated understanding of | |
| | patient information into medical record | |
| 5 | Interview subsystem shall provide a means | Usability |
| | to completely record | |
| | visual, auditory, and written information | |
| 6 | Interview subsystem shall be usable | Usability |
| | by colorblind people | |
| 7 | Interview subsystem shall have consistent | Usability |
| | color and symbol use | |
| 8 | Interview subsystem shall provide a reminder | Usability |
| | to collect patient's chief concern/complaint | |
| 9 | Interview subsystem shall provide a means to | Functionality |
| | collect provider's perceived urgency of problems | |
| 10 | Interview subsystem shall provide a means to | Functionality |
| | set an agenda for interview questions | |
| 11 | Interview subsystem shall provide a means | Functionality |
| | to collect patient self-knowledge | |
| 12 | Interview subsystem shall provide a | Functionality |
| | reminder to ask open ended | |
| | (patient centered) interview questions | |
| 13 | Interview subsystem shall provide a | Functionality |
| | reminder to ask close ended | |
| | (doctor centered) interview questions | |
| 14 | Interview subsystem shall provide a means | Functionality |
| | to collect and integrate existing | |
| | diagnosis from medical records | |
| 15 | Interview subsystem shall provide a means to | Functionality |
| | characterize patient's symptoms | |
| 16 | Interview subsystem shall provide a | Functionality |
| | means to show which questions | |
| | the patient responded to for the | |
| | physician's interface | |
| 17 | Interview subsystem shall provide a means | Functionality |
| | for the physician to update patient | |
| | medical records during the interview | |
| 18 | The HCT shall provide a means for the | Usability |
| | physician to enter and annotate data | |
| 19 | The HCT shall provide means to depict | Functionality |
| | the chronology of symptoms and | |
| | other diagnostic information | |
| 20 | Interview subsystem shall provide a reminder | Functionality |
| | to ask *correct* test requisitions | |
| 21 | Interview subsystem shall integrate information | Functionality |
| | for physical exam and diagnosis process | |
| — | Physical Examination Functionality | |
| 22 | The subsystem shall provide a means | Functionality |
| | to communicate with the | |
| | Electronic Medical Records | |
| 23 | The subsystem may provide a means to allow | Functionality |
| | the Patient to access to their medical records | |
| 24 | The subsystem shall update patient electronic | Functionality |
| | medical records with exam data and findings | |
| 25 | The subsystem shall record data in the | Functionality |
| | absence of an internet connection | |
| 26 | The subsystem should provide a means to | Functionality |
| | record and recognize user's voice sounds | |
| 27 | The subsystem shall provide a means | Functionality |
| | to guarantee the safety of users | |
| | (physician, patient, Maintenance staff) | |
| | when it is in use | |
| 28 | The subsystem shall provide a means to | Functionality |
| | listen to and record heart sounds | |
| 29 | The system shall provide a means to | Functionality |
| | correctly record sounds from the physical | |
| | examination in presence of | |
| | noisy environments | |
| 30 | The subsystem should provide a means to | Functionality |
| | capture blood pressure and heart rate | |
| 31 | The subsystem shall provide a means to | Functionality |
| | calculate and record the heart rate | |
| 32 | The subsystem shall provide a means to | Functionality |
| | listen to and record lung sounds | |
| 33 | The subsystem should provide a means | Functionality |
| | to capture dermatologic image | |
| 34 | The subsystem shall provide a means to view | Functionality |
| | and capture images and videos of the eyes | |
| 35 | The subsystem shall provide a means to capture | Functionality |
| | pictures with a resolution at 1900*1200 | |
| 36 | The subsystem shall provide a means to view | Functionality |
| | and capture images and videos of the ears | |
| 37 | The subsystem should provide a means to | Functionality |
| | record handwritten notes | |
| 38 | Corners and edges of fixed and handheld | Functionality |
| | equipment to which the bare skin of | |
| | the crew could be exposed shall be | |
| | rounded as specified | |
| 39 | Any surface to which the bare skin of the crew is | Functionality |
| | exposed shall not cause epidermis/dermis | |
| | interface temperature to exceed the pain | |
| | threshold limit of 44° C. (111.2° F.) | |
| 40 | Any surface to which the bare skin of the crew is | Functionality |
| | exposed shall not | |
| | cause skin temperature to drop below | |
| | the pain threshold limit of 10° C. (50° F.) | |
| 41 | The subsystem shall be portable | Usability |
| 42 | The subsystem shall be hand held | Usability |
| 43 | The subsystem shall have a means for grasping, | Usability |
| | handling, and carrying | |
| 44 | The subsystem shall weigh less than | Usability |
| | or equal to 1 Lb | |
| 45 | Subsystem shall be capable of continuous and | Usability |
| | autonomous operation for no less than 2 hours | |
| 46 | The subsystem shall be resistant to impact | Usability |
| | from dropping or bumping | |
| 47 | The subsystem shall adapt to a physician's | Usability |
| | *mental model* of exam flow | |
| 48 | The subsystem shall operate in an *intuitive* | Usability |
| | manner requiring no written instructions | |
| 49 | The subsystem shall be easy to clean | Usability |
| 50 | The subsystem shall have a germ-resistant surface | Usability |
| 51 | The subsystem's elements shall be | Usability |
| | smaller than 14″ × 9″ × 3″ | |
| 52 | The subsystem shall provide mechanisms | Usability |
| | to prevent mistakes that may occur | |
| | when using the subsystem | |
| 53 | The subsystem should provide assistance to the | Usability |
| | physician to make an appropriate diagnosis | |
| 54 | Subsystem's interfaces shall be easy to navigate | Usability |
| 55 | The subsystem shall provide feedback | Usability |
| | to the physician with regards their actions | |
| | and the consequences of them | |
| 56 | The subsystem shall provide a means to | Usability |
| | inform the users when it is not | |
| | working properly or needs calibration | |
| 57 | The subsystem should use graphics and icons | Usability |
| | to make operations understandable | |
| 58 | The subsystem's interfaces should avoid | Usability |
| | absolute judgment limits | |
| 59 | The subsystem's interface should exploit | Usability |
| | top-down processing | |
| 60 | The subsystem's interface should | Usability |
| | exploit redundancy | |
| 61 | The subsystem's interface should use discriminable | Usability |
| | elements | |
| 62 | The subsystem's interface should exploit the | Usability |
| | principle of pictorial realism | |
| 63 | The subsystem's should provide a recovery | Usability |
| | solution to physician when an error or | |
| | misuse occur | |
| 64 | The subsystem shall present patient's personal | Functionality |
| | information in all pages | |
| 65 | The subsystem shall provide patient's medical | Functionality |
| | information in all pages to reduce | |
| | information access cost | |
| 66 | The subsystem shall present patient's medical | Functionality |
| | information in at least text and photo formats | |
| 67 | The subsystem shall provide access to the copies | Functionality |
| | of reports for test results issued by medical labs | |
| 68 | The subsystem shall be able to connect to the | Functionality |
| | EMR to retrieve and update patient medical | |
| | information | |
| 69 | The subsystem shall present patient medical | Functionality |
| | history in the chronological order | |
| 70 | The subsystem shall have the ability to save | Functionality |
| | patient's explanation of his/her problem | |
| 71 | The subsystem shall allow the clinician | Functionality |
| | to take notes at all of the stages | |
| | of the diagnostic process and save it | |
| 72 | The subsystem shall provide access to electronic | Functionality |
| | medical references such | |
| | as Pub Med, NLM and Medline and | |
| | electronic decision support tools | |
| 73 | The physician should be able to list | Functionality |
| | potential hypotheses | |
| 74 | The physician should be able to take notes of | Functionality |
| | his/her findings physical examination | |
| 75 | The physician should be able to add to and reduce | Functionality |
| | from the hypotheses list and prioritize them | |
| 76 | The subsystem shall present all symptoms | Functionality |
| | associated with each diagnosis in the hypotheses | |
| | list to reduce workload on working memory | |
| 77 | The subsystem's interface shall present the list of | Functionality |
| | suggested diagnoses after the clinician has | |
| | reviewed the patient's data | |
| 78 | The physician should be able to order medical tests | Functionality |
| 79 | The physician should be able to update patient's | Functionality |
| | medical history | |
| 80 | The subsystem shall require the | Functionality |
| | physician's confirmation before updating | |
| | the patient's medical records | |
| 81 | The subsystem shall be able to take a record of | Functionality |
| | physician's final understanding of diagnoses, | |
| | feedback, and recommendations | |
| 82 | The physician should be able to share the patient's | Functionality |
| | problem with remote specialists | |
| 83 | The subsystem shall provide the clinician with the | Functionality |
| | feedback of final diagnosis(es) | |
| — | Diagnosis Usability | |
| 84 | The subsystem shall utilize a standard format in the | Usability |
| | design of different pages of the interface | |
| 85 | The subsystem shall have a consistent design with | Usability |
| | the user mental model | |
| 86 | The subsystem shall use color-coding | Usability |
| | corresponding to established conventions | |
| 87 | The subsystem shall use color coding for | Usability |
| | redundancy gain, not to impact | |
| | those with color deficit issues | |
| 88 | The subsystem shall not use more than 5 to 7 hues | Usability |
| | in a single screen to avoid absolute judgment limits | |
| 89 | The subsystem shall aid the clinician | Usability |
| | to keep track of the diagnostic process | |
| | by showing the current step of the | |
| | process within the interface | |
| 90 | The subsystem shall provide the ability of | Usability |
| | moving among different pages easily to | |
| | reduce the information access cost | |
| 91 | The subsystem shall integrate related information | Usability |
| | to reduce information access cost | |
| 92 | The subsystem shall utilize color and shape | Usability |
| | coding to facilitate the perception of information | |
| 93 | The subsystem shall utilize accepted symbols, | Usability |
| | icons, colors and abbreviations to convey | |
| | information reliably and quickly | |
| 94 | The subsystem shall provide unambiguous labels | Usability |
| | for the buttons that can be easily read | |
| | (symbol size, contrast, color) | |
| 95 | The subsystem shall implement alarms that meet or | Usability |
| | exceed normal hearing and visual limits of the user | |
| 96 | The subsystem shall intensify auditory signals | Usability |
| | sufficiently according to the amount | |
| | of ambient noise | |
| 97 | The subsystem shall optimize the legibility of | Usability |
| | visual signals considering the effect of ambient | |
| | illumination | |
| 98 | The subsystem shall utilize alternative physical | Usability |
| | forms for an alarm when it is very serious | |
| | Debiasing Tools | |
| 99 | The application shall provide cognitive | Functionality |
| | debiasing tools to | |
| | reduce the likelihood of Premature Closure, | |
| | Representativeness, Anchoring, Availability, | |
| | and overconfidence | |
| 100 | Design of debiasing memory tools shall be | Usability |
| | consistent with iOS standards | |
| 101 | Design of debiasing memory tools shall be | Usability |
| | consistent with the rest of the application standards | |
| 102 | Subtle but clear visible and audible feedback shall | Usability |
| | be implemented for using debiasing memory tools | |
| 103 | Appropriate metaphors or images should be used to | Usability |
| | convey the functionality of the tool | |
| 104 | Design of debiasing memory tools shall not | Functionality |
| | increase the user's cognitive burden | |
| 105 | Appropriate label should be used to convey the | Functionality |
| | functionality of the memory tools quickly | |
| 106 | Debiasing memory tools should only act as a | Functionality |
| | mnemonic and should not interfere with the | |
| | process of decision-making | |
| 107 | Debiasing memory tools should be specifically | Functionality |
| | attributed to different stages of diagnosis | |
| 108 | Debiasing memory tools should provide a brief | Functionality |
| | checklist for checking essential information | |
| | at each stage like medical history and lab | |
| | test results at the gathering data level | |
| 109 | Anchoring debiasing memory tool shall | Functionality |
| | encourage the physician to review all | |
| | the patient's information before | |
| | making decision | |
| 110 | Anchoring debiasing memory tool shall | Functionality |
| | discourage the physician to weigh the | |
| | information that supports their initial | |
| | hypothesis more heavily than other information | |
| 111 | Availability debiasing memory tool | Functionality |
| | shall encourage the physician to consider | |
| | the true base rate of illnesses | |
| 112 | Availability debiasing memory tool | Functionality |
| | shall encourage the physician to consider | |
| | the history of recent diagnoses | |
| 113 | The subsystem should represent the actual | Functionality |
| | occurrence probability of a hypothesis to mitigate | |
| | the effect of Representativeness bias | |
| 114 | Representativeness debiasing memory tool shall | Functionality |
| | encourage the physician to search for | |
| | inconsistencies between patient's symptoms | |
| | and the potential diagnosis | |
| 115 | Confirmation bias debiasing memory tool shall | Functionality |
| | encourage the physician to look for more data that | |
| | prove disconfirming evidence | |
| 116 | Confirmation bias debiasing memory tool shall | Functionality |
| | discourage the physician to misinterpret | |
| | ambiguous cues to support the hypothesis | |
| | Treatment Plan | |
| 117 | Any buttons located on the encounter form user | Usability |
| | interface shall be *big enough* | |
| 118 | The encounter form user interface shall be | Usability |
| | limited to 10 items of information per page | |
| 119 | The encounter form user interface shall use | Usability |
| | neutral colors to the maximum extent possible | |
| 120 | The encounter form user interface | Usability |
| | shall be *uncluttered* | |
| 121 | The encounter form shall use a font | Usability |
| | that is *easy to read* | |
| 122 | The encounter form should use bi-directional | Usability |
| | flow (the user can go forwards and | |
| | backwards through the interface) | |
| 123 | The subsystem shall auto-save continuously and | Usability |
| | allow the provider to undo changes | |
| 124 | The subsystem shall allow the physician to | Functionality |
| | customize certain usability aspects | |
| 125 | The subsystem shall provide input | Functionality |
| | feedback (i.e.: haptic feedback, audio | |
| | feedback, etc.) when a selection is made | |
| 126 | The subsystem shall prevent unauthorized access | Usability |
| | to the encounter form | |
| 127 | The encounter form user interface shall be | Usability |
| | adaptable to both left-handed and | |
| | right-handed users | |
| 128 | The subsystem shall provide access | Functionality |
| | to online references | |
| | for the physician, especially for treatment options | |
| 129 | The subsystem shall have accessibility to the | Functionality |
| | patient's electronic medical records | |
| 130 | The subsystem shall provide a summary of all | Functionality |
| | current medications indicated in the patient's | |
| | medical records or initial interview checklist | |
| 131 | The subsystem shall provide a summary of all | Functionality |
| | allergies indicated in the patient's medical | |
| | records or initial interview checklist | |
| 132 | The subsystem shall provide accessibility to a | Functionality |
| | summary of patient's existing condition | |
| 133 | The subsystem shall provide accessibility to | Functionality |
| | patient's past treatments | |
| 134 | The subsystem shall provide means to | Functionality |
| | alert the physician of any possible | |
| | interactions between entered medications | |
| 135 | The subsystem should have means to prioritize and | Functionality |
| | display a relevant subset of possible treatment | |
| | options depending on the information obtained | |
| | during the patient interview and diagnosis | |
| 136 | The subsystem shall have means to indicate patient | Functionality |
| | refusal to treatment | |
| 137 | The subsystem shall allow the physician to input | Functionality |
| | alternate treatments other than those suggested | |
| | by the toolkit | |
| 138 | The subsystem shall have means to | Functionality |
| | provide the physician needful information | |
| | for any treatment implementation | |
| 139 | The subsystem shall have means to recall | Functionality |
| | previously prescribed medications and display | |
| | it for the provider | |
| 140 | The subsystem should display last frequencies and | Functionality |
| | dosages used for any recurring medication from | |
| | previous encounters | |
| 141 | The subsystem shall allow the physician to input | Functionality |
| | alternate dosages and frequencies for medications | |
| | other than those suggested by the subsystem | |
| 142 | The subsystem shall have means to send | Functionality |
| | prescriptions to local pharmacy and | |
| | export a printed prescription to | |
| | external pharmacies | |
| 143 | The subsystem shall have means to indicate if the | Functionality |
| | pharmacy have received the prescription | |
| 144 | The subsystem shall have means for | Functionality |
| | the physician to educate the patient | |
| | about their diagnosis and treatment | |
| 145 | The subsystem shall provide access to educational | Functionality |
| | online references for the patient | |
| 146 | The subsystem form shall be consistent with | Usability |
| | physician's standardized templates | |
| 147 | The subsystem shall provide means for | Functionality |
| | the physician to update the encounter | |
| | form with all treatment decisions | |
| 148 | The subsystem shall provide a summary | Functionality |
| | of treatment for the physician's | |
| | approval before completing the | |
| | documentation of the treatment | |

What is claimed is:

1. A patient-centered Healthcare Toolkit, comprising:
a set of identification (ID) devices to uniquely identify each of a set of patients;
a set of electronic tablets having wireless connectivity configured to read the set of ID devices, at least one of the set of electronic tablets being a patient intake tablet to collect patient self-knowledge of their problems;
a set of medical measurement devices each configured with wireless connectivity to operate with one of the set of electronic tablets to gather at least one of physiologic, radiographic and bio-chemical data; and
a local manager station to wirelessly connect with the set of electronic tablets and including an enterprise management system (EMS) using a physician “mental model” of exam flow to create a patient-centered encounter form and any test requisitions for each of the medical measurement devices, and provide correct and consistent guidelines to operators of each of the set of electronic tablets.

2. The toolkit of claim 1, wherein the local manager station is configured to access the electronic health record (EMR) of the patient and further configured to generate a continuity of care document (CCD) or HL7 file based on the results of the patient-centered encounter forms for import into the EMR of the patient.

3. The toolkit of claim 2, wherein the EMS uses as control inputs medical references, guidelines, system factors, and information from the EMR including patient factors, provider factors, patient perceived problems, medical records, and test results to create the patient-centered encounter form.

4. The toolkit of claim 1 wherein the local manager's station includes a fail-safe backup system and the station is further configured to coordinate in real-time a team of responders to operate the set of electronic tablets and the set of medical measurement devices and wherein the EMS is configured to record an urgency of a problem by an operator of a medical measurement device.

5. The toolkit of claim 1 further comprising an out-brief station including one of the set of electronic tablets to collect patient satisfaction and provide a health dashboard, a medical problem list, educational links and material, patient test results, basic recommendations for follow-up, and if required, appropriate referrals for follow on care.

6. The toolkit of claim 1 further comprising a carrying case configured to store and prevent breakage during harsh conditions the set of electronic tablets, the set of medical measurement devices, the set of ID devices and the local manager station.

7. The toolkit of claim 1 wherein the local manager station is configured to create a local community health and epidemiology database and work table based on tests and outcomes of each of the set of patients.

8. The toolkit of claim 8 wherein the EMS uses the local community health and epidemiology database and work table to help provide individual patient diagnosis and treatment and feedback to patient physician and reflect the probability of hypothesis taking into account the local community health and epidemiology database group results and probabilities.

9. The toolkit of claim 7 further comprising an out-brief station wherein the EMS is configured to create support groups for respective patients having similar illnesses in the local community and provide information how the patient may access any appropriate support groups at the out-brief station.

10. The toolkit of claim 7 wherein the set of medical measurement devices are configured to provide audio, visual, and written information for the local community health and epidemiology database including at least one of table wave files with expanded fast Fourier transforms and photo-cardiology to allow for tele-medicine.

11. The toolkit of claim 1 wherein the EMS is configured to create diagnostic work tables with debiasing memory to prevent a physician from weighing an initial hypothesis more favorably over other hypothesis suggested by the EMS.

12. The toolkit of claim 1 wherein the local manager station is configured to create a local community health and epidemiology database based on tests and outcomes of each of the set of patients, and the EMS is configured to consider the true base rate of illnesses with respect to both the local community health and epidemiology work table and global databases and use the local community health and epidemiology database to further pinpoint diagnosis.

13. The toolkit of claim 1 wherein the EMS is configured to allow the operator of one of the set of medical measurement devices, for each patient, to track patient emotional state and metrics, including anxiety and depression.

14. The toolkit of claim 1 wherein the set of medical measurement devices are configured to send to other specialists additional information of the physical status and health of the patient not evaluated by the toolkit, including pictures of teeth and moles.

15. The toolkit of claim 1 wherein the EMS is configured to create a treatment work table with options, costs, possible side effects, and access to medical databases and search engines.

16. The toolkit of claim 1 wherein the EMS is configured to provide a recovery solution for an operator of one of the set of medical measurement devices when an error occurs.

17. A patient-centered Healthcare Toolkit, comprising:
a set of identification (ID) devices to uniquely identify each of a set of patients;
an electronic tablet having wireless connectivity configured to read the set of ID devices, the electronic tablet including a set of patient-centered encounter forms including a patient intake encounter form to collect patient self-knowledge of their problems;
a set of medical measurement devices each configured with wireless connectivity to operate with the electronic tablet via respective patient-centered encounter forms created from an enterprise management system (EMS) using a physician “mental model” of exam flow to gather at least one of physiologic, radiographic and bio-chemical data, any test requisitions for each of the medical measurement devices, and provide correct and consistent guidelines to an operator of the electronic tablet.

18. An intelligent human-machine interface for a patient-centered healthcare toolkit, comprising:
an interface shell including a patient identification (ID) device reader to uniquely identify individual patients with a patient ID;
a set of function agents that interface to one or more electronic medical records using the patient ID, one or more knowledge bases and one or more clinic databases; and
a set of system agents including one or more dynamic medical measurement device agents to wirelessly gather at least one of physiologic, radiographic and bio-chemical data, the system agents to wirelessly communicate with the interface shell to one or more electronic tables and that create work tables of patient-centered encounter forms based on the user ID for each medical measurement device using the interface shell and the set of function agents, the system agents further including at least an interview agent, a diagnostic agent, a treatment agent and an out-brief agent, wherein the diagnostic agent and the treatment agent use a physician mental model of diagnostic and treatment work tables that are intuitive and anticipatory in use with graphic interfaces that create a graphic and text space to think about and manipulate data and physical findings.

19. A method for providing an intelligent human-machine interface, comprising the steps of:
providing an interface shell;
providing a system agent including one or more dynamic, knowledge-based software object sub-agents including a patient system sub-agent adapted to model and track the state of a patient encounter form;
providing a healthcare toolkit system agent adapted to model, track, and facilitate medical measurement work table and other form interface functions, wherein the interface shell is adapted to provide a hardware and software interface between the system agent, the function agent, and a set of medical measurement devices to wirelessly gather at least one of physiologic, radiographic and bio-chemical data; and
providing a system hierarchy model of the structural elements of a system and a functional model of the patient encounter based on a physician mental model of patient centered medical encounter flow including,
wirelessly retrieving medical data from the set of medical measurement devices, and communication systems via a set of function agents necessary to implement functionality;
identifying component and interface specifications for the acquisition and integration of the medical measurement devices;
creating functional model software specifications; and
utilizing a model based knowledge base to construct the hierarchy and operations.

20. A management system for a healthcare toolkit using a physician “mental model” of exam flow, comprising:
an interview agent to communicate to a client intake station which includes a set of identification (ID) devices to uniquely identify each of a set of patients, the interview agent further to wirelessly communicate with a wireless electronic tablet to read the set of ID devices, the electronic tablet including a set of patient-centered encounter forms including a patient intake encounter form to collect patient self-knowledge of their problem and allow for the requisition of any test requisitions;
a set of medical measurement agents to communicate with a respective set of medical measurement devices (MMD) to gather at least one of physiologic, radiographic and bio-chemical data for the test requisitions, each MMD configured with wireless connectivity to operate with a respective wireless electronic tablet via respective patient-centered MMD work tables and encounter forms based on the ID devices along with clear and consistent guidelines to follow;
a diagnostic agent and a treatment agent using a physician mental model of diagnostic and treatment work tables that are intuitive and anticipatory in use with graphic interfaces that create a graphic and text space to think about and manipulate data and physical findings; and
an out-brief agent to communicate with an out-brief station where at least one of copies of the test results, prescriptions, therapy choices, education information, follow-up appointments, referrals, and billing are presented to an appropriate patient with the respective ID device.
